(19) United States
(12) Patent Application Publication
(10) Pub. No.: US 2024/0231016 A9
(43) Pub. Date: Jul. 11, 2024

(54) OPTICAL MODULE

(71) Applicant: HISENSE BROADBAND MULTIMEDIA TECHNOLOGIES CO., LTD., Qingdao (CN)

(72) Inventors: Yongjun YU, Qingdao (CN); Haixiang ZHANG, Qingdao (CN); Chunlun FANG, Qingdao (CN); Xiaokuo ZHANG, Qingdao (CN); Jianwei MU, Qingdao (CN)

(21) Appl. No.: 18/398,637

(22) Filed: Dec. 28, 2023

Related U.S. Application Data
(63) Continuation of application No. PCT/CN2022/128415, filed on Oct. 28, 2022.

(30) Foreign Application Priority Data
Jun. 13, 2022 (CN) 202210665581.5
Jun. 13, 2022 (CN) 202210667216.8
Jun. 13, 2022 (CN) 202221475039.5
Jun. 13, 2022 (CN) 202221475327.0
Jun. 13, 2022 (CN) 202221481014.6

(51) Int. Cl. G02B 6/42; H04B 10/40

(52) U.S. Cl. CPC G02B 6/4214; G02B 6/4246; H04B 10/40

(57) ABSTRACT

An optical module that includes an optical transceiver component and a fiber adapter. The optical transceiver component includes a first tubular shell, a light splitting assembly in the first tubular shell, first and second light emission assemblies and first and second light reception assemblies connected to the first tubular shell, and a bracket inserted onto the first tubular shell. The first tubular shell is provided therein with an optical element and an inclined plane located below the optical element. The inclined plane is configured to reflect a reflected beam from a transmission surface of the optical element. The light splitting assembly includes a support frame and three optical splitters. The first light reception assembly is inclinedly disposed relative to a central axis of the first tubular shell via a bracket, while the second light reception assembly is perpendicularly assembled on the first tubular shell.

### CROSS-REFERENCE TO RELATED APPLICATIONS

This application is a continuation application of PCT/CN2022/128415 which claims priorities to Chinese patent applications No. 202210665581.5, 202210667216.8, 202221475327.0, 202221475039.5 and 202221481014.6, filed on Jun. 13, 2022 with the China National Intellectual Property Administration (CNIPA), the entire disclosures of which are incorporated herein by reference.

### FIELD

This application relates to the technical field of optical communication technology, particularly to an optical module.

### BACKGROUND

With the development of new business and application models such as cloud computing, mobile internet and video, the development and progress of optical communication technology has become increasingly important. Also, in optical communication technology, optical modules are tools for achieving mutual conversion between optical and electrical signals and are one of key devices in optical communication devices. With the development of optical communication technology, it is desirable to continue to increase the transmission rate of the optical module.

### SUMMARY

According to a first aspect, some embodiments of this disclosure provide an optical module including: a circuit board; an optical transceiver component electrically connected to the circuit board; and a fiber adapter connected to the optical transceiver component. The optical transceiver component includes a first tubular shell, a light splitting assembly, a first light emission assembly, a second light emission assembly, a first light reception assembly, a second light reception assembly and a bracket. The first tubular shell has an inner cavity, and first and second incident light ports, first and second reception light ports as well as an integrated emission and reception light port that are communicated with the inner cavity, wherein the fiber adapter is plugged into the inner cavity through the integrated emission and reception light port; and the inner cavity is provided with an optical element and an inclined plane; the optical element is configured to transmit and reflect emission beams coming into the first tubular shell; the inclined plane is located below the optical element, is disposed opposite to a transmission surface of the optical element, and is configured to reflect a reflected emission beam from the transmission surface again such that a re-reflected emission beam does not pass through the second incident light port. The light splitting assembly is disposed in the inner cavity of the first tubular shell downstream of the optical element along a beam emission direction inside the first tubular shell, and includes a support frame and a first optical splitter, a second optical splitter and a third optical splitter disposed on the support frame, wherein the first optical splitter is configured to reflect multi-path reception beams coming from the fiber adapter, the second optical splitter is configured to split the multi-path reception beams reflected by the first optical splitter such that a first reception beam of the multi-path reception beams directly transmit through the second optical splitter and a second reception beam of the multi-path reception beams is reflected again at the second optical splitter and then come into the third optical splitter, and the third optical splitter is configured to allow the second reception beam re-reflected by the second optical splitter to transmit through the third optical splitter. The first light emission assembly is connected to the first tubular shell at the first incident light port, is configured to generate a first emission beam, and allows the first emission beam to pass through the optical element and be coupled to the fiber adapter after passing through the first optical splitter. The second light emission assembly is connected to the first tubular shell at the second incident light port, is configured to generate a second emission beam, and allows the second emission beam to be reflected by the optical element and then be coupled to the fiber adapter after passing through the first optical splitter. The first light reception assembly is connected to the first tubular shell at the first reception light port, is configured to receive the transmitted second reception beam transmitted through the third optical splitter. The second light reception assembly is connected to the first tubular shell at the second reception light port, is configured to receive the first reception beam transmitted through the second optical splitter, and is assembled on the first tubular shell in such a way that it is perpendicular to a central axis of the first tubular shell. The bracket is disposed at the first reception light port, and includes a mounting surface and an insertion surface that are opposite to each other, wherein the insertion surface is configured to be inserted into the first reception light port to fix the bracket to the first reception light port, the mounting surface is inclined such that a distance between the mounting surface and the central axis of the first tubular shell gradually decreases in the beam emission direction inside the first tubular shell; and wherein the first light reception assembly is assembled on the mounting surface and is thus inclined relative to the central axis of the first tubular shell.

According to a second aspect, some embodiments disclosed herein provide an optical module including: a circuit board; an optical transceiver component electrically connected to the circuit board; and a fiber adapter connected to the optical transceiver component. The optical transceiver component includes a second tubular shell, a plurality of optical splitters, a light emission assembly and a light reception assembly. The second tubular includes an inner cavity, and a light inlet, a light outlet as well as an emission and reception light port that are communicated with the inner cavity, wherein the fiber adapter is plugged into the inner cavity through the emission and reception light port; wherein the inner cavity is provided with an optical element and a slope, the optical element is configured to transmit and/or reflect an emission beam that comes into the second tubular shell, the slope is located below the optical element and opposite to a transmission surface of the optical element, and is configured to reflect an emission beam reflected by the transmission surface again, such that the emission beam which is re-reflected does not pass through the light inlet; wherein a fixing bracket is disposed on the second tubular shell which is protruded relative to the second tubular shell, the fixing bracket is provided with a mounting recess, with one end of the mounting recess being formed with an opening, and the other end of the mounting recess being provided with an inclined mounting platform communicated with the light outlet; and wherein a distance between the mounting platform and a central axis of the second tubular shell gradually decreases in a beam emission direction inside the second tubular shell. The plurality of optical splitters are arranged in the inner cavity in correspondence to the emission and reception light port and the light outlet, and are configured to reflect and split reception beams of different wavelengths transported from the fiber adapter. The light emission assembly is connected to the second tubular shell via the light inlet, is configured to generate an emission beam, and allows the emission beam to sequentially pass through the optical element and the optical splitters and then be coupled to the fiber adapter. The light reception assembly is disposed on the mounting platform, with a preset angle being formed between the light reception assembly and the second tubular shell, and is configured to receive the reception beam reflected by the optical splitters.

### DRAWINGS

In order to illustrate technical solutions disclosed in this disclosure more clearly, a brief description on the accompanying drawings required in some embodiments of this disclosure will be given below. It is obvious that the accompanying drawings described below are only those of some embodiments of this disclosure, and for those skilled in the art, other accompanying drawings can also be obtained based on these drawings. In addition, the accompanying drawings described below can be regarded as schematic diagrams and are not restrictions on actual size of the relevant products, actual process of the relevant methods, actual timing of signals, etc. involved in the disclosed embodiments.

FIG. 1 is a schematic diagram showing a connection relationship of an optical communication system according to some embodiments;

FIG. 2 is a schematic partial structural diagram of an optical network terminal according to some embodiments;

FIG. 3 is a structural schematic diagram of an optical module according to some embodiments;

FIG. 4 is an exploded schematic diagram of an optical module according to some embodiments;

FIG. 5 is a structural schematic diagram of an optical transceiver component of an optical module according to some embodiments;

FIG. 6 is an exploded schematic diagram of an optical transceiver component of the optical module according to some embodiments;

FIG. 7 is a structural schematic diagram of a tubular shell of the optical transceiver component of the optical module according to some embodiments;

FIG. 8 is a structural schematic diagram of the tubular shell according to some embodiments, viewed from a second angle;

FIG. 9 is a structural schematic diagram of the tubular shell according to some embodiments, viewed from a third angle;

FIG. 10 is a sectional view of the tubular shell according to some embodiments;

FIG. 11 is a structural schematic diagram of a support frame for a light splitting assembly of an optical module according to some embodiments;

FIG. 12 is a structural schematic diagram of the support frame according to some embodiments, viewed from another angle;

FIG. 13 is a sectional view of the support frame according to some embodiments;

FIG. 14 is a sectional view illustrating an assembly of a light splitting assembly and a fiber adapter of an optical module according to some embodiments;

FIG. 15 is a schematic diagram illustrating a reception light path of an optical module according to some embodiments;

FIG. 16 is a structural schematic diagram of a bracket for an optical transceiver component of an optical module according to some embodiments;

FIG. 17 is a structural schematic diagram of the bracket according to some embodiments, viewed from another angle;

FIG. 18 is a sectional view of an optical transceiver component of an optical module according to some embodiments;

FIG. 19 is a structural schematic diagram of another optical transceiver component of an optical module according to some embodiments;

FIG. 20 is an exploded schematic diagram of the optical transceiver component shown in FIG. 19;

FIG. 21 is a structural schematic diagram of a tubular shell of the optical transceiver component shown in FIG. 19;

FIG. 22 is a structural schematic diagram of the tubular shell shown in FIG. 21, viewed from another angle;

FIG. 23 is a sectional schematic view of the tubular shell shown in FIG. 21;

FIG. 24 is a sectional schematic view of the tubular shell shown in FIG. 21, viewed from another angle;

FIG. 25 is a sectional schematic view of the optical transceiver component shown in FIG. 19; and

FIG. 26 is a structural schematic diagram of a light reception assembly of an optical module according to some embodiments.

### DETAILED DESCRIPTION

Technical solutions according to some embodiments of the present disclosure will be described clearly and completely with reference to the accompanying drawings below. Obviously, these embodiments are merely some, but not all, of the embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials, or characteristics related to the embodiment(s) or example(s) are included in at least one embodiment or example of the present disclosure. Illustrative representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined with “first” and “second” may explicitly or implicitly include one or more of the features. In the description of the embodiments of the present disclosure, the term “a/the plurality of” or “multiple” means two or more unless otherwise specified.

In the description of some embodiments, the term “coupled” and “connected” and their derivatives may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “configured to” herein means an open and inclusive language, which does not exclude devices that are configured to perform additional tasks or steps.

As used herein, the term “about”, “substantially” or “approximately” includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

In optical communication technology, the light is used to carry information to be transmitted, and the optical signal carrying the information is transmitted to an information processing device such as a computer through an information transmission device such as an optical fiber or an optical waveguide, so as to achieve transmission of the information. Since optical signal has a characteristic of passive transmission when being transmitted through the optical fiber or the optical waveguide, low-cost and low-loss information transmission may be achieved. In addition, a signal transmitted by the information transmission device such as the optical fiber or the optical waveguide is the optical signal, while a signal that may be recognized and processed by the information processing device such as the computer is an electrical signal. Therefore, in order to establish information connection between the information transmission device such as the optical fiber or the optical waveguide and the information processing device such as the computer, interconversion between the electrical signal and the optical signal needs to be achieved.

An optical module implements a function of the interconversion between the optical signal and the electrical signal in the field of optical fiber communication technology.

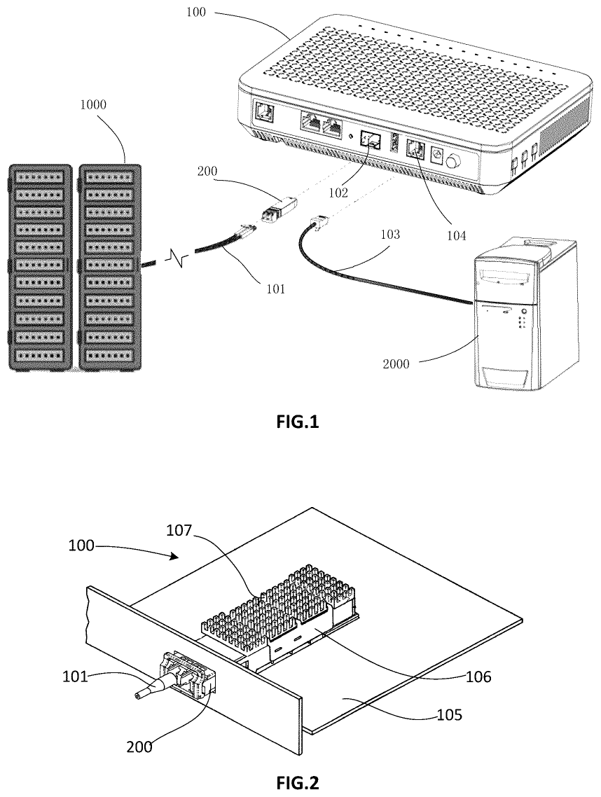

FIG. 1 is a schematic diagram illustrating a connection relationship of an optical communication system according to an exemplary embodiment. As shown in FIG. 1, the optical communication system may include a remote server 1000, a local information processing device 2000, an optical network terminal 100, an optical module 200, an optical fiber 101 and a network cable 103.

One end of the optical fiber 101 may be connected to the remote server 1000, and the other end thereof may be connected to the optical network terminal 100 through the optical module 200.

One end of the network cable 103 may be connected to the local information processing device 2000, and the other end thereof may be connected to the optical network terminal 100. The local information processing device 2000 may be a router, an exchanger, a computer, a mobile phone, a tablet computer, a television or the like.

Generally, the optical module 200 may include an optical port and an electrical port. The optical port is configured to be connected with the optical fiber 101, such that a bidirectional optical signal connection is established between the optical module 200 and the optical fiber 101; and the electrical port is configured to be coupled to the optical network terminal 100, such that that a bidirectional electrical signal connection is established between the optical module 200 and the optical network terminal 100. Thus, the connection between the optical fiber 101 and the optical network terminal 100 is established. For example, an optical signal from the optical fiber 101 is converted into an electrical signal by the optical module 200 and the electrical signal is then input into the optical network terminal 100, and an electrical signal from the optical network terminal 100 is converted into an optical signal by the optical module 200 and the optical signal is then input into the optical fiber 101.

The optical network terminal 100 may include an optical module interface 102 and a network cable interface 104. The optical module interface 102 is configured to be coupled to the optical module 200, and the network cable interface 104 is configured to be coupled to the network cable 103. For example, the optical network terminal 100 transmits an electrical signal from the optical module 200 to the network cable 103, and transmits a signal from the network cable 103 to the optical module 200. Therefore, the optical network terminal 100, as a master monitor of the optical module 200, may monitor operation of the optical module 200. In addition to the optical network terminal 100, the master monitor of the optical module 200 may include an optical line terminal (OLT).

A bidirectional signal transmission channel between the remote server 1000 and the local information processing device 2000 may be established through the optical fiber 101, the optical module 200, the optical network terminal 100 and the network cable 103.

FIG. 2 is a partial structural schematic diagram of an optical network terminal according to an exemplary embodiment of the present disclosure. In order to illustrate a connection relationship between the optical module 200 and the optical network terminal 100 clearly, FIG. 2 only shows the structure of the optical network terminal 100 related to the optical module 200. As shown in FIG. 2, the optical network terminal 100 may further include a circuit board 105 disposed within a housing, a cage 106 disposed on a surface of the circuit board 105, and a radiator 107 disposed on the cage 106.

The optical module 200 is inserted into the cage 106 of the optical network terminal 100 and then is fixed by the cage 106. Thus, heat generated by the optical module 200 is conducted to the cage 106, and then is dissipated via the radiator 107. After the optical module 200 is inserted into the cage 106, the electrical port of the optical module 200 is connected to an electrical connector inside the cage 106, thereby establishing a bidirectional electrical signal connection between the optical module 200 and the optical network terminal 100.

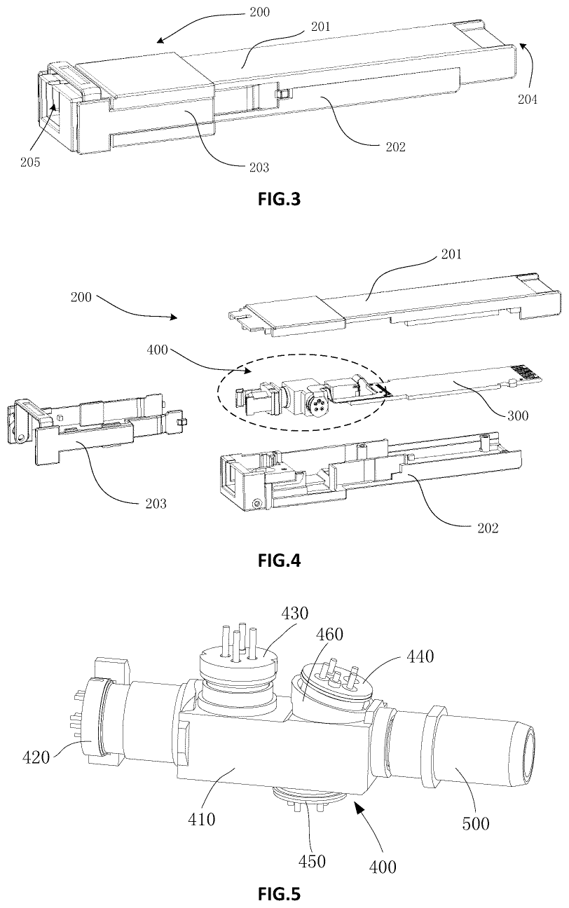

FIG. 3 is a structural schematic diagram of an optical module according to an embodiment of the present disclosure. FIG. 4 is an exploded schematic diagram of the optical module according to an embodiment of the present disclosure. As shown in FIG. 3 and FIG. 4, an optical module 200 may include a shell, a circuit board 300 and an optical transceiver component 400 disposed within the shell.

The shell may include an upper shell part 201 and a lower shell part 202, the upper shell part 201 is covered on the lower shell part 202 to form the shell having two openings. An outer contour of the shell is generally in a cuboid shape.

A direction along a connecting line between the two openings 204 and 205 may be consistent with a length direction of the optical module 200 or inconsistent with a longitudinal direction of the optical module 200. For example, the opening 204 may be located at an end of the optical module 200 (right end in FIG. 3), and the opening 205 may also be located at an end of the optical module 200 (left end in FIG. 3). Alternatively, the opening 204 is located at an end of the optical module 200, while the opening 205 is located at a side of the optical module 200. The opening 204 may be an electrical port, and a golden finger of the circuit board 300 extends from the electrical port 204 and is inserted into a master monitor (such as the optical network terminal 100). The opening 205 may be an optical port configured to be coupled to an external optical fiber 101, such that the external optical fiber 101 is connected to the optical transceiver component 400 disposed within the optical module 200.

An assembling way in which the upper shell part 201 is combined with the lower shell part 202 facilitates to mount the circuit board 300, the optical transceiver component 400 and other components into the shell, such that the upper shell part 201 and the lower shell part 202 form a protective enclosure for these components.

In some embodiments, the upper shell part 201 and the lower shell part 202 are generally made of metal materials for promoting electromagnetic shielding and heat dissipation.

In some embodiments, the optical module 200 may further include an unlocking part 203 disposed outside the shell. The unlocking part 203 is configured to achieve a fixed connection between the optical module 200 and the master monitor or release the fixed connection between the optical module 200 and the master monitor.

The circuit board 300 may be provided with circuit wiring, electronic elements and chips, and the electronic elements and chips are connected together via the circuit wiring according to a circuit design so as to achieve functions such as power supply, electrical signal transmission and grounding. For example, the electronic elements include capacitors, resistors, transistors and Metal-Oxide-Semiconductor Field-Effect Transistors (MOSFETs). For example, the chips include microcontroller units (MCUs), laser driver chips, limiting amplifiers, Clock and Data Recovery (CDR) chips, power management chips and digital signal processing (DSP) chips.

The circuit board 300 is generally a rigid circuit board. Also, the rigid circuit board may achieve a carrying function due to a relatively hard material thereof.

The circuit board 300 further includes a gold finger formed on an end face thereof, which is composed of multiple pins independent from each other. The circuit board 300 may be inserted into the master monitor and be conductively connected to the electrical connector disposed within the master monitor via the golden finger. The golden finger may be disposed only on the surface of one side of the circuit board 300 (such as the upper surface shown in FIG. 4), or on the surfaces of both the upper and lower sides of the circuit board 300 to provide a larger number of pins and adapt to situations with high demand for pin numbers. The golden finger is configured to establish an electrical connection with the master monitor to achieve power supply, grounding, Inter-Integrated Circuit (I2C) signal transmission, data signal transmission or the like.

Of course, it is possible to use a flexible circuit board in some optical module. The flexible circuit board is generally used in cooperation with the rigid circuit board to serve as a supplement to the rigid circuit board.

The optical transceiver component 400 may include a light emission assembly configured to implement emission of an optical signal and a light reception assembly configured to implement reception of an optical signal. For example, the light emission assembly and the light reception assembly are combined together to form an integrated optical transceiver component.

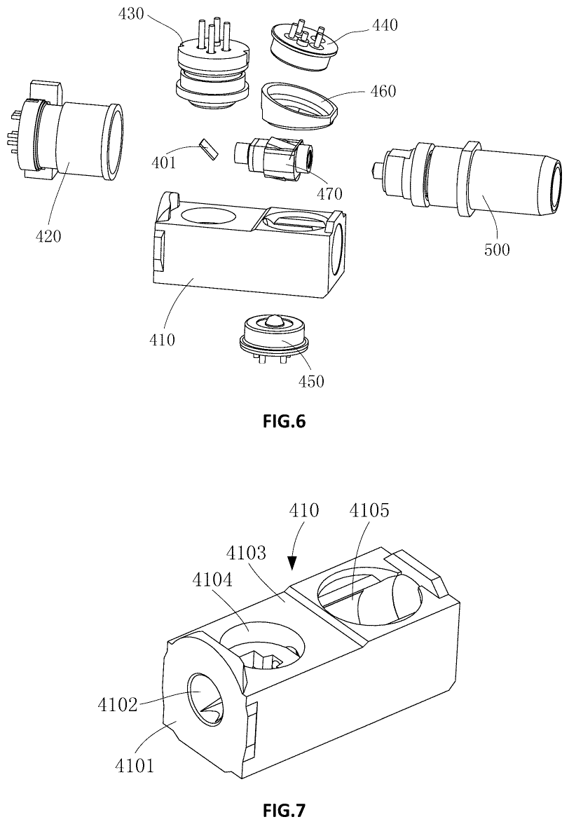

FIG. 5 is a structural schematic diagram of an optical transceiver component of an optical module according to some embodiments, and FIG. 6 is an exploded schematic diagram of the optical transceiver component of the optical module according to some embodiments. As shown in FIGS. 5 and 6, the optical module may include an optical transceiver component 400, which may include a first tubular shell 410, a light emission assembly and a light reception assembly. The first tubular shell 410 includes an incident light port, an integrated emission and reception light port and a reception light port. The light emission assembly is connected to the first tubular shell 410 via the incident light port, the light reception assembly is connected to the first tubular shell 410 via the reception light port, and the fiber adapter 500 is connected to the first tubular shell 410 via the integrated emission and reception light port. The fiber adapter 500 can serve as a joint for an optical fiber, allowing the optical fiber to be coupled through an optical interface. In this way, a beam emitted by the light emission assembly comes into the first tubular shell 410 through the incident light port, and can then be coupled to the fiber adapter 500 through the integrated emission and reception light port, achieving emission of light; and a reception beam transported by the fiber adapter 500 comes into the first tubular shell 410 through the integrated emission and reception light port, and then is transported to the light reception assembly through the reception light port, achieving reception of light.

In some embodiments, the optical transceiver component 400 may only include one light emission assembly and one light reception assembly. The first tubular shell 410 may only include one incident light port, one integrated emission and reception light port and one reception light port. The light emission assembly may be connected to the first tubular shell 410 via the incident light port, the light reception assembly may be connected to the first tubular shell 410 via the reception light port, and the fiber adapter 500 may be connected to the first tubular shell 410 via the integrated emission and reception light port. In this way, the optical transceiver component 400 is able to achieve one-path beam emission and one-path beam reception.

In some embodiments, the optical transceiver component 400 may include two light emission assemblies and two light reception assemblies. The first tubular shell 410 may include two incident light ports, two reception light ports and one integrated emission and reception light port. That is, the optical transceiver component 400 includes a first light emission assembly 420, a second light emission assembly 430, a first light reception assembly 440, and a second light reception assembly 450, and the first tubular shell 410 includes a first incident light port and a second incident light port, a first reception light port and a second reception light port, and an integrated emission and reception light port. The first light emission assembly 420 is connected to the first tubular shell 410 via the first incident light port, the second light emission assembly 430 is connected to the first tubular shell via the second incident light port, the first light reception assembly 440 is connected to the first tubular shell 410 via the first reception light port, the second light reception assembly 450 is connected to the first tubular shell 410 via the second reception light port, and the fiber adapter 500 is connected to the first tubular shell 410 via the integrated emission and reception light port.

In some embodiments, an optimized structural design is performed on the second light emission assembly 430, and materials, such as TO56 1490 header and tubular cap that are compatible with a low-speed GPON OLT, are used to achieve a low-cost and universal design of the product.

The first incident light port is arranged in a left or first side of the first tubular shell 410, the second incident light port is arranged in an upper or top side of the first tubular shell 410, the first reception light port is arranged in the upper or top side of the first tubular shell 410, the second reception light port is arranged in a lower or bottom side of the first tubular shell 410, and the integrated emission and reception light port is arranged in a right or second side of the first tubular shell 410. That is, the first incident light port is arranged opposite to the integrated emission and reception light port, the second incident light port and the first reception light port are arranged on the same side of the first tubular shell 410, and the first reception light port is arranged opposite to the second reception light port.

An emission direction of an emission beam emitted by the first light emission assembly 420 is opposite to a beam reception direction of the fiber adapter 500. That is, a beam emission direction of the first light emission assembly 420 is parallel to the circuit board 300, and the light reception direction of the fiber adapter 500 is also parallel to the circuit board 300. In this way, the emission beam emitted by the first light emission assembly 420 comes into the first tubular shell 410 through the first incident light port, and directly passes through the first tubular shell 410 and then is coupled to the fiber adapter 500, achieving emission of one path of light.

In some embodiments, a light exiting end of the first light emission assembly 420 is provided with a coupling lens. A laser beam emitted from a laser disposed inside the first light emission assembly 420 is converted into a converged beam via the coupling lens, and the converged beam is incident into the first tubular shell 410 through the first incident light port.

In some embodiments, a first emission beam emitted by the first light emission assembly 420 is transported in a direction of a central axis of the integrated emission and reception light port, such that the first emission beam passes through the first tubular shell 410 and comes into the fiber adapter 500. It should be noted that the central axis of the integrated emission and reception light port refers to an axis that passes through a center of the integrated emission and reception light port and is perpendicular to a plane where the integrated emission and reception light port is located.

An emission direction of an emission beam emitted by the second light emission assembly 430 differs from the beam reception direction of the fiber adapter 500. In other words, the emission direction of the second light emission assembly 430 is perpendicular to the circuit board 300, and the beam reception direction of the fiber adapter 500 is parallel to the circuit board 300. Therefore, it is desirable to reflect, via the first tubular shell 410, the emission beam emitted by the second light emission assembly 430 such that a reflected emission beam reflected by the first tubular shell is in the same direction as the beam reception direction of the fiber adapter 500. In this way, the emission beam emitted by the second light emission assembly 430 comes into the first tubular shell 410 through the second incident light port, and is reflected by the first tubular shell 410 and then is coupled to the fiber adapter 500, achieving emission of another path of light.

In some embodiments, a second emission beam emitted by the second light emission assembly 430 is reflected via the first tubular shell 410, the reflected second emission beam is transported in the direction of the central axis of the integrated emission and reception light port, such that the reflected second emission beam passes through the first tubular shell 410 and into the fiber adapter 500.

In some embodiments, an optical element 401 is provided in the first tubular shell 410 at an intersection of an emission light path of the first light emission assembly 420 and an emission light path of the second light emission assembly 430. That is, the optical element 401 is located in the beam emission direction of the first light emission assembly 420 and the beam emission direction of the second light emission assembly 430.

The optical element 401 has functions of both transmitting the first emission beam and reflecting the second emission beam, such that the first emission beam and the reflected second emission beam can be combined via the optical element 401, and the combined beam is coupled to the fiber adapter 500. In this way, the first emission beam emitted by the first light emission assembly 420 can directly pass through the optical element 401, and the second emission beam emitted by the second light emission assembly 430 is reflected via the optical element 401 such that the reflected second emission beam has the same emission direction as the first emission beam, and thus the first emission beam and the reflected second emission beam are combined at the optical element 401.

The optical element 401 has a transmission surface and a reflection surface. The transmission surface is arranged aligning with the first light emission assembly 420 such that the first emission beam emitted by the first light emission assembly 420 directly passes through the optical element 401 through the transmission surface. The reflection surface is arranged corresponding to the second light emission assembly 430 such that the second emission beam emitted by the second light emission assembly 430 is reflected via the reflection surface, and the reflected second emission beam is transported in the emission direction of the first emission beam, and the reflected second emission beam is combined with the first emission beam at the reflection surface.

In some embodiments, the optical element 401 may be a filter sheet, a prism attached with a filter sheet or a filter film, or other structures, as long as the optical element 401 has the functions of transmitting the first emission beam and reflecting the second emission beam.

In some embodiments, the optical element 401 is a filter sheet, which has a smaller volume and occupies smaller space and thus facilitates obtaining a compact design of the optical transceiver component 400.

In some embodiments, by making simulation and dispersion analysis of the light paths, an astigmatism generated by the optical element 401 can be offset against an inherent astigmatism of the laser of the first light emission assembly 420, achieving a high coupling efficiency of 60% and achieving a high utilization of homemade chips.

In some embodiments, the first emission beam may have a wavelength of 1270 nm, 1310 nm, 1490 nm, or 1577 nm, etc., and correspondingly, the second emission beam may have a wavelength of 1270 nm, 1310 nm, 1490 nm, or 1577 nm, etc.

In some embodiments, the wavelength of the first emission beam is 1577 nm, and the wavelength of the second emission beam is 1490 nm. Accordingly, the optical element 401 has the functions of transmitting a beam having a wavelength of 1577 nm and reflecting a beam having a wavelength of 1490 nm. The first emission beam of 1577 nm emitted by the first light emission assembly 420 directly passes through the optical element 401, and the second emission beam of 1490 nm emitted by the second light emission assembly 430 is reflected via the optical element 401, such that the reflected second emission beam is combined with the first emission beam and then is transported to the fiber adapter 500.

A reception direction in which the first light reception assembly 440 receives a beam and the beam reception direction of the fiber adapter 500 are in different directions, in other words, the reception direction of the first light reception assembly 440 is perpendicular to the circuit board 300, while the beam reception direction of the fiber adapter 500 is parallel to the circuit board 300, therefore it is desirable to reflect the reception beam from the fiber adapter 500 via the first tubular shell 410, such that a direction of the reception beam after being reflected (also referred to as reflected reception beam) is in the same direction as the reception direction of the first light reception assembly 440. In this way, external beam received by the fiber adapter 500 comes into the first tubular shell 410 via the integrated emission and reception light port, and the reflected reception beam from the first tubular shell 410 is then coupled to the first light reception assembly 440, achieving reception of one path of light.

A reception direction in which the second light reception assembly 450 receives a beam and the beam reception direction of the fiber adapter 500 are in different directions, that is, the reception direction of the second light reception assembly 450 is perpendicular to the circuit board 300, while the beam reception direction of the fiber adapter 500 is parallel to the circuit board 300. Therefore, it is desirable to reflect the reception beam from the fiber adapter 500 via the first tubular shell 410, such that a direction of the reception beam after being reflected (also referred to as reflected reception beam) is in the same direction as the reception direction of the second light reception assembly 450. In this way, the external beam received by the fiber adapter 500 comes into the first tubular shell 410 via the integrated emission and reception light port, and the reflected reception beam from the first tubular shell is coupled to the second light reception assembly 450, achieving reception of another path of light.

In some embodiments, a light splitting assembly 470 is disposed within the first tubular shell 410 in a reception direction in which the integrated emission and reception light port receives the external beam, and the light splitting assembly 470 is close to the first light reception assembly 440 and the second light reception assembly 450. Multi-path reception beams transported by the fiber adapter 500 are split by the light splitting assembly 470 and then transported to the first light reception assembly 440 and the second light reception assembly 450, respectively.

The light splitting assembly 470 has functions of reflection and light splitting. First and second reception beams coming into the first tubular shell 410 through the integrated emission and reception light port are reflected and split at the light splitting assembly 470. After being split via the light splitting assembly 470, the first reception beam is transported to the first light reception assembly 440, and the second reception beam is transported to the second light reception assembly 450.

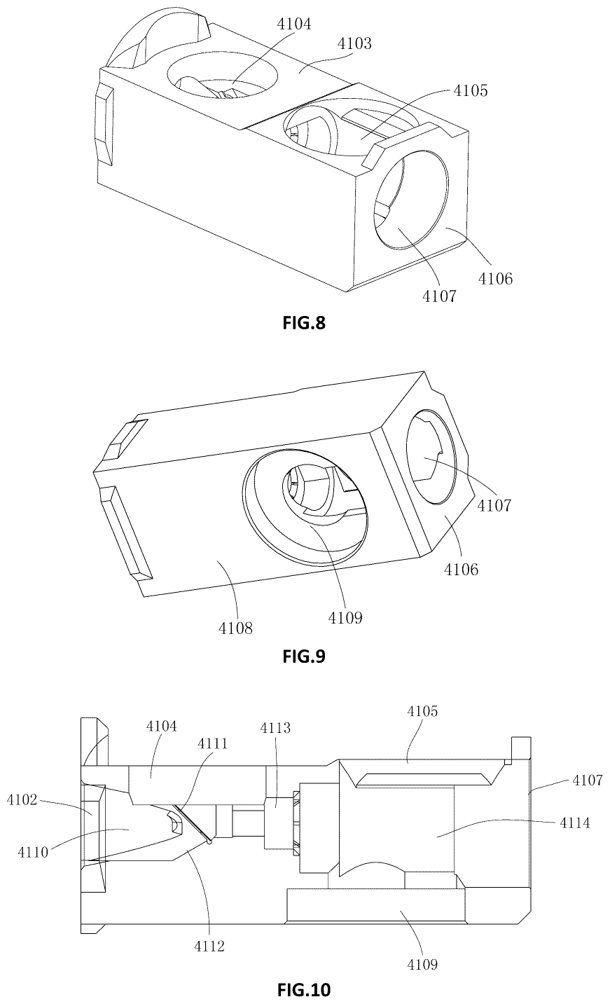

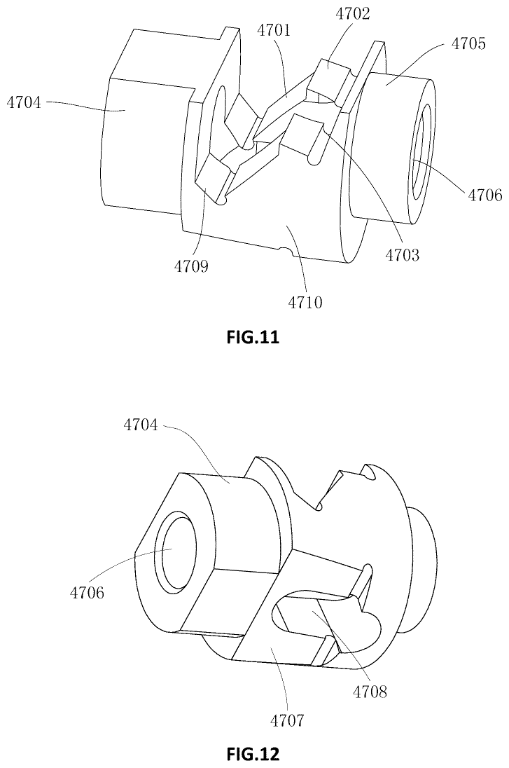

FIG. 7 is a structural schematic diagram of a tubular shell of an optical module according to some embodiments, FIG. 8 is a structural schematic diagram, viewed from a second angle, of the tubular shell of the optical module according to some embodiments, FIG. 9 is a structural schematic diagram, viewed from a third angle, of the tubular shell of the optical module according to some embodiments, and FIG. 10 is a sectional schematic view of the tubular shell of the optical module according to some embodiments. As shown in FIGS. 7-10, the first tubular shell 410 includes a first lateral side 4101, a top side 4103, a second lateral side 4106, and a bottom side 4108. The first lateral side 4101 is opposite to the second lateral side 4106, and the top side 4103 is opposite to the bottom side 4108. Two ends of the top side 4103 are respectively connected to the first lateral side 4101 and the second lateral side 4106.

The first lateral side 4101 is provided with a first incident light port 4102 communicating with the inner cavity of the first tubular shell 410. The first light emission assembly 420 is connected to the first tubular shell 410 at the first lateral side 4101, such that the first emission beam emitted by the first light emission assembly 420 is incident into the first tubular shell 410 through the first incident light port 4102. In some embodiments, the first light emission assembly 420 can be fixedly connected to the first lateral side 4101 via an adjustable sleeve 480.

In some embodiments, when the first light emission assembly 420 is fixedly connected to the first lateral side 4101 of the first tubular shell 410 via the adjustable sleeve, it is possible to apply a laser welding after a power coupling between the first light emission assembly 420 and the first tubular shell 410 as well as the fiber adapter 500 is established, to improve the coupling efficiency between the first light emission assembly 420 and the fiber adapter 500.

The top side 4103 is provided with a second incident light port 4104 communicating with the inner cavity of the first tubular shell 410. The second light emission assembly 430 is connected to the first tubular shell 410 via the second incident light port 4104, such that the second emission beam emitted by the second light emission assembly 430 is incident into the first tubular shell 410 via the second incident light port 4104. In some embodiments, the second light emission assembly 430 can be plugged into the second incident light port 4104, with an outer wall of the second light emission assembly 430 being adhered and fixedly connected to an inner wall of the second incident light port 4104.

The top side 4103 is also provided with a first reception light port 4105 which is communicated with the inner cavity of the first tubular shell 410. The first light reception assembly 440 is connected to the first tubular shell 410 via the first reception light port 4105, such that the first reception beam received through the first tubular shell 410 is incident into the first light reception assembly 440 through the first reception light port 4105.

The second lateral side 4106 is provided with an integrated emission and reception light port 4107 which is communicated with the inner cavity of the first tubular shell 410. The fiber adapter 500 is connected to the first tubular shell 410 via the integrated emission and reception light port 4107, such that the reception beam transported by the fiber adapter 500 comes into the first tubular shell 410 through the integrated emission and reception light port 4107. In some embodiments, the fiber adapter 500 is plugged into the first tubular shell 410 through the integrated emission and reception light port 4107, such that the fiber adapter 500 is fixedly connect with the first tubular shell 410.

The bottom side 4108 is provided with a second reception light port 4109 which is communicated with the inner cavity of the first tubular shell 410. The second light reception assembly 450 is connected to the first tubular shell 410 at the bottom side 4108, such that the second reception beam received through the first tubular shell 410 comes into the second light reception assembly 450 through the second reception light port 4109. In some embodiments, the second light reception assembly 450 can be plugged into the second reception light port 4109, with an outer wall of the second light reception assembly 450 being adhered and fixedly connected to an inner wall of the second reception light port 4109.

The inner cavity of the first tubular shell 410 includes a first inner cavity 4110, a second inner cavity 4113 and a third inner cavity 4114. The first inner cavity 4110 is communicated with the third inner cavity 4114 via the second inner cavity 4113, the first inner cavity 4110 is communicated with the first incident light port 4102 and the second incident light port 4104, and the optical element 401 is disposed within the first inner cavity 4110. The third inner cavity 4114 is communicated with the first reception light port 4105, the second reception light port 4109 and the integrated emission and reception light port 4107, and the light splitting assembly 470 is disposed within the third inner cavity 4114.

A support platform 4111 is provided in the first inner cavity 4110 in an inclined manner, such that the support platform 4111 is inclined from top to bottom in a direction from the first incident light port 4102 towards the second inner cavity 4113, that is, a distance between the support platform 4111 and the second incident light port 4104 gradually increases in the emission direction of the first emission beam, such that a first angle is formed between the support platform 4111 and the emission direction of the first emission beam. In some embodiments, the first angle is 45°.

The transmission surface of the optical element 401 is adhered to the support platform 4111, and thus there is also the first angle between the optical element 401 and the emission direction of the first emission beam. The second emission beam emitted by the second light emission assembly 430 is reflected on the reflection surface of the optical element 401, and the reflected second emission beam (that is, the second emission beam after being reflected by the reflection surface) has the same emission direction as the first emission beam.

In some embodiments, in order to enable the first emission beam emitted by the first light emission assembly 420 to easily pass through the optical element 401, the support platform 4111 is provided therein with a light hole which is communicated with the first inner cavity 4110. In this way, the first emission beam emitted by the first light emission assembly 420 passes through the first inner cavity 4110 and the light hole, and comes onto the optical element 401, and the first emission beam directly passes through the optical element 401.

In some embodiments, the light hole of the support platform 4111 may be an opening, or a platform area made of transparent material, as long as the first emission beam emitted by the first light emission assembly 420 can pass through the optical element 401 through the light hole.

In some embodiments, when the first emission beam is transmitted through the optical element 401, most (about 95%) of the first emission beam would directly pass through the optical element 401, but there is still a portion (about 5%) of the first emission beam that may be reflected at the transmission surface of the optical element 401, and the reflected portion of the first emission beam (that is, the portion of the first emission beam reflected at the transmission surface) may be reflected again at the inner wall of the first inner cavity 4110, the re-reflected portion of the first emission beam may come into the second light emission assembly 430 through the second incident light port 4104, causing an interference of a reflected light on the second emission beam.

In order to avoid the interference of the reflected portion of the first emission beam on the second emission beam, an inclined plane 4112 is disposed on the inner wall of the first inner cavity 4110 below the support platform 4111, and a distance between the inclined plane 4112 and the second incident light port 4104 gradually decreases in the emission direction of the first emission beam. In this way, after a portion of the first emission beam is reflected at the transmission surface of the optical element 401, the reflected portion of the first emission beam is reflected again on the inclined plane 4112. Due to the inclined arrangement of the inclined plane 4112, the re-reflected portion of the first emission beam diverge outward, which can prevent the re-reflected portion of first emission beam from being incident into the second incident light port 4104, and thus effectively reduces the interference of the reflected light on the second emission beam.

In order to reduce a possibility that the portion of the first emission beam reflected on the inclined plane 4112 is incident into the second incident light port 4104, a second angle is formed between the inclined plane 4112 and an emission optical axis of the first emission beam. In some embodiments, the second angle is between 20° and 50°.

In some embodiments, the first emission beam emitted by the first light emission assembly 420 passes through the optical element 401 and then is transported to the fiber adapter 500. However, due to changes in mediums and potential reflection occurring during light propagations at interfaces between different mediums, when the first emission beam passes through the second inner cavity 4113 and the third inner cavity 4114 and comes onto an end face of the fiber inside the fiber adapter 500, most of the first emission beam directly come into the fiber adapter 500 through the end face of the fiber, while a small portion of the first emission beam may be reflected at the end face of the fiber, and the reflected portion of the first emission beam may backtrack to the first light emission assembly 420, affecting the emission performance of the first light emission assembly 420.

In order to avoid the reflected portion of the first emission beam from backtracking to the first light emission assembly 420, it is possible to provide an isolator within the second inner cavity 4113. The first emission beam transmitted through the optical element 401 directly passes through the isolator and comes into the fiber adapter 500. The isolator can isolate the reflected portion of the first emission beam from the end face of the fiber of the fiber adapter 500 to prevent the reflected portion of the first emission beam from returning to the first light emission assembly 420, ensuring the emission performance of the first light emission assembly 420.

In some embodiments, with the coupling lens at the light exiting end of the first light emission assembly 420, the first emission beam emitted by the first light emission assembly 420 is converted into a converged beam. The converged beam has a smallest facula at a focal point, and thus the isolator can be placed at a position where the focal point of the first emission beam is located. In this case, the isolator may have a minimal size, ensuring that an aperture in the second inner cavity 4113 required for the isolator is minimal, which facilitates obtaining a compact design of the first tubular shell 410.

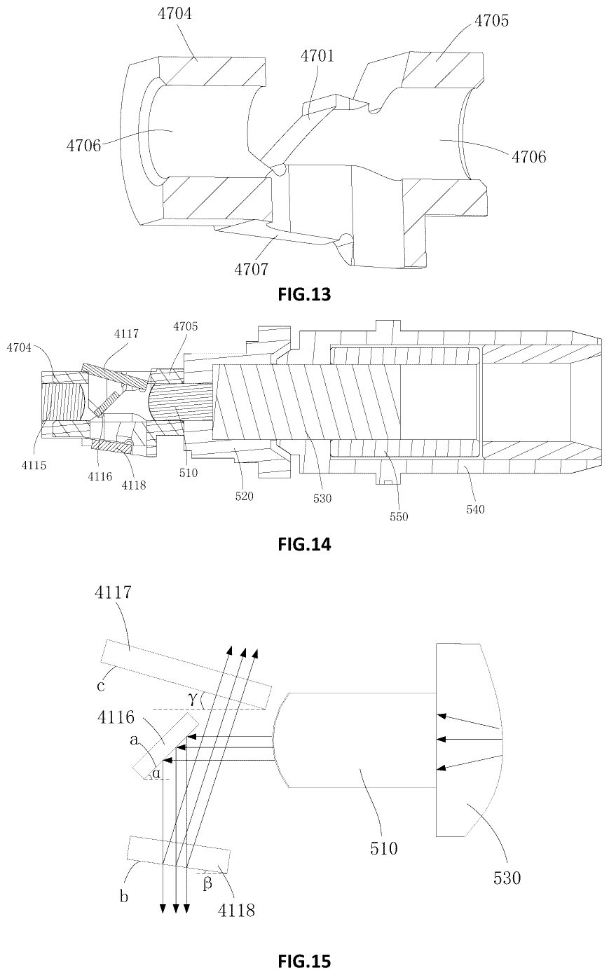

The light splitting assembly 470 to be disposed within the third inner cavity 4114 includes a support frame 4710 and multiple optical splitters fixed on the support frame 4710. The support frame 4710 is fixed within the third inner cavity 4114, and thus the multiple optical splitters are fixed within the third inner cavity 4114 via the support frame 4710. FIG. 11 is a structural schematic diagram of a support frame of an optical module according to some embodiments, FIG. 12 is a structural schematic diagram illustrating, from another angle, the support frame in the optical module according to some embodiments, and FIG. 13 is a sectional schematic view of the support frame of the optical module according to some embodiments. As shown in FIGS. 11, 12 and 13, the support frame 4710 includes a first connecting portion 4704, a support portion and a second connecting portion 4705. The first connecting portion 4704 is connected to the second connecting portion 4705 via the support portion, the first connecting portion 4704 is facing away from the fiber adapter 500, and the second connecting portion 4705 is fixedly connected to the fiber adapter 500.

The support frame 4710 is provided therein with a light hole 4706 that runs through the first connecting portion 4704, the support portion and the second connecting portion 4705. The first emission beam transmitted through the optical element 401 and the second emission beam reflected at the optical element 401 pass through the light hole 4706 of the support frame 4710 and then come into the fiber adapter 500.

The support portion is provided thereon with a first support surface 4701, a first stop surface 4709, a second support surface 4702, a second stop surface 4703 and a third support surface 4707. The first support surface 4701 is inclined, that is, a distance between the first support surface 4701 and the first connecting portion 4704 gradually increases in the emission direction of the first emission beam (from left to right). The first stop surface 4709 is disposed on a bottom left of the first support surface 4701, and one optical splitter bears, at an end face thereof, against the first stop surface 4709, and a side face of the optical splitter is adhered to the first support surface 4701, thereby fixing the optical splitter to the support portion via the first support surface 4701 and the first stop surface 4709.

The second support surface 4702 is inclined, that is, a distance between the second support surface 4702 and the second connecting portion 4705 gradually decreases in the emission direction of the first emission beam (from left to right). The second stop surface 4703 is located on the bottom right of the second support surface 4702, and another optical splitter bears, at an end face thereof, against the second stop surface 4703, and a side face of said another optical splitter is adhered on the second support surface 4702, and the other end face of said another optical splitter abuts on a top surface of the first connecting portion 4704, thereby fixing said another optical splitter on the support portion through the second support surface 4702, the second stop surface 4703 and the top surface of the first connecting portion 4704.

In some embodiments, a section of the light hole in the support portion runs through the first support surface 4701 and the second support surface 4702, and the optical splitter fixed on the second support surface 4702 is located above the optical splitter fixed on the first support surface 4701.

The third support surface 4707 is disposed on one side of the support portion facing the second reception light port 4109. The third support surface 4707 is inclined, that is, a distance between the third support surface 4707 and the second reception light port 4109 gradually decreases in the emission direction of the first emission beam. A side face of a third optical splitter is adhered to the third support surface 4707, thereby fixing the third optical splitter onto the support portion through the third support surface 4707.

In some embodiments, a through hole 4708 is disposed in the third support surface 4707, and the through hole is communicated with the section of the light hole in the support portion. Multi-path reception beams transported by the fiber adapter 500 are reflected at the first optical splitter disposed on the first support surface 4701, and the reflected reception beams, which are reflected by the first optical splitter, come onto the second optical splitter disposed on the third support surface 4707. The second optical splitter splits the multiple-path reception beams, such that one path of reception beam passes through the second optical splitter and is incident into the second light reception assembly 450, and another path of reception beam is reflected again at the second optical splitter, the re-reflected reception beam directly passes through the third optical splitter disposed on the second support surface 4702 and is incident into the first light reception assembly 440.

FIG. 14 is a sectional schematic view of an assembly of a light splitting assembly and a fiber adapter of an optical module according to some embodiments. As shown in FIG. 14, the fiber adapter 500 includes a connecting sleeve 520, an internal optical fiber 530, an outer sleeve 540 and an inner sleeve 550. The connecting sleeve 520 is fixedly connected to the outer sleeve 540, the inner sleeve 550 is fixed on a sidewall of an inner cavity of the outer sleeve 540, and the internal optical fiber 530 is fixed within the inner cavity of the outer sleeve 540 via the inner sleeve 550. The connecting sleeve 520 is provided with a mounting hole which is communicated with the inner cavity of the outer sleeve 540. A converging lens 510 is disposed in the mounting hole, with the converging lens protruding from the connecting sleeve 520 and being inserted into a section of the light hole in the second connecting portion 4705. In this way, the first and second reception beams transported by the internal optical fiber 530 disposed in the fiber adapter 500 are converted into converged beams via the converging lens 510, and the converged beams come into the support frame 4710 through the section of the light hole in the second connecting portion 4705.

In some embodiments, a collimating lens 4115 is disposed in a section of the light hole in the first connecting portion 4704. The collimating lens 4115 is configured to convert the first emission beam transmitted through the optical element 401 and the second emission beam reflected at the optical element 401 into collimated beams, respectively. The collimated beams directly pass through the optical splitter disposed on the first support surface 4701 and come into the converging lens 510, and the collimated beams are converted into converged beams via the converging lens 510, and the converged beams converge into the internal fiber 530.

The optical splitter assembly 470 may include a first optical splitter 4116, a second optical splitter 4118 and a third optical splitter 4117. The first optical splitter 4116 faces the fiber adapter 500 and is configured to reflect multi-path reception beams from the fiber adapter 500. The second optical splitter 4118 faces the second light reception assembly 450 and is configured to split the reflected multi-path reception beams from the first optical splitter 4116, such that one-path reception beam directly passes through the second optical splitter 4118 and comes into the second light reception assembly 450, and another-path reception beam is reflected again at the second optical splitter 4118. The third optical splitter 4117 faces the first light reception assembly 440 and is configured to transmit the re-reflected reception beam from the second optical splitter 4118 such that the transmitted reception beam is incident into the first light reception assembly 440.

FIG. 15 is a schematic diagram illustrating a reception light path of an optical module according to some embodiments. As shown in FIG. 15, a lower end face of the first optical splitter 4116 bears against the first stop surface 4709, and the side face thereof is adhered to the first support surface 4701. A third angle α is formed between the first optical splitter 4116 and the emission optical axis of the first emission beam. The first optical splitter 4116 has a function of reflecting the first reception beam and the second reception beam, and is configured to reflect the first reception beam and the second reception beam transported from the fiber adapter 500. In some embodiments, the third angle α is between 40° and 50°.

In some embodiments, the first optical splitter 4116 is provided with a reflection surface on a portion thereof exposed through the light hole. When the first and second reception beams transported by the fiber adapter 500 come onto the reflection surface of the first optical splitter 4116, the first and second reception beams are reflected at the reflection surface a of the first optical splitter 4116.

The second optical splitter 4118 is adhered, at the side face thereof, to the third support surface 4707, and is located outside the support frame 4710, and a fourth angle β is formed between the second optical splitter 4118 and the emission optical axis. The second optical splitter 4118 has a function of reflecting the first reception beam and transmitting the second reception beam, and is configured to transmit and reflect the first and second reception beams reflected from the first optical splitter 4116. In some embodiments, the fourth angle β is between 6° to 20°.

In some embodiments, the second optical splitter 4118 is provided with a transmission surface on an upper surface thereof exposed through the through-hole 4708, and the second optical splitter 4118 is provided with a transmission-reflection surface b on a lower surface thereof outside the support frame 4710. The first reception beam and the second reception beam reflected by the first optical splitter 4116 come onto the second optical splitter 4118, the first reception beam is transmitted through the transmission surface of the upper surface to the transmission-reflection surface b of the lower surface, and is reflected again on the transmission-reflection surface b, and the second reception beam sequentially passes through the transmission surface of the upper surface and the transmission-reflection surface b of the lower surface, and is then transmitted through the second optical splitter 4118 and is incident into the second light reception assembly 50 through the second reception light port 4109.

If the transmission-reflection surface is provided on the upper surface of the second optical splitter 4118, it is necessary to adhere the lower surface of the second optical splitter 4118 to the third support surface 4707. In this case, it is also necessary to place the second optical splitter 4118 in the through hole 4708, which causes the support frame 4710 to have an increased size. On the contrary, when the transmission-reflection surface is provided on the lower surface of the second optical splitter 4118, the second optical splitter 4118 can be attached to the outside of the support frame 4710, and only one through hole 4708 needs to be provided to allow the reception beam to come onto the second optical splitter 4118, thereby effectively reducing the size of the support frame 4710 and facilitating obtaining a compact design of the first tubular shell 410.

The third optical splitter 4117 bears, at a right end face thereof, against the second stop surface 4703, and abuts, at a left end face thereof, on the top surface of the first connecting portion 4704, and adheres, at a lower side thereof, to the second support surface 4702. A fifth angle γ is formed between the third optical splitter 4117 and the emission optical axis. The third optical splitter 4117 has a function of transmitting the first reception beam and is thus configured to transmit the first reception beam reflected by the second optical splitter 4118. In some embodiments, the fifth angle γ is between 10° and 22°.

In some embodiments, a lower surface of the third optical splitter 4117 is provided with a transmission surface c. The first reception beam reflected by the second optical splitter 4118 directly passes through the third optical splitter 4117, and the first reception beam transmitted through the third optical splitter 4117 then comes into the first light reception assembly 440 through the first reception light port 4105.

In some embodiments, the third angle α between the first optical splitter 4116 and the emission optical axis inside the first tubular shell 410 is 45°, the fourth angle β between the second optical splitter 4118 and the emission optical axis is 8°, the fifth angle γ between the third optical splitter 4117 and the emission optical axis is 16°. In this way, the first and second reception beams transported by the fiber adapter 500 are reflected to the second optical splitter 4118 via the first optical splitter 4116. The reflected second reception beam directly passes through the second optical splitter 4118, the reflected first reception beam is reflected again at the second optical splitter 4118, and the re-reflected first reception beam directly passes through the third optical splitter 4117.

In some embodiments, the first optical splitter 4116, the second optical splitter 4118 and the third optical splitter 4117 may be filter sheets, prisms attached with filter sheets or filter films, or other structures, without specific limitations herein.

In some embodiments, the first optical splitter 4116, the second optical splitter 4118 and the third optical splitter 4117 are all filter sheets. The filter sheet has a smaller volume and occupies smaller space, and thus facilitates obtaining a compact design of the first tubular shell 410.

The first reception beam may have a wavelength of 1270 nm, 1310 nm, 1490 nm, 1577 nm, etc., without specific limitations herein. Correspondingly, the second reception beam may have a wavelength of 1270 nm, 1310 nm, 1490 nm, or 1577 nm, etc., without specific limitations herein.

In some embodiments, the first reception beam has the wavelength of 1270 nm, and the second reception beam has the wavelength of 1310 nm. Therefore, the first optical splitter 4116 has a function of reflecting a beam having the wavelengths of 1270 nm and a beam having the wavelengths of 1310 nm, the second optical splitter 4118 has a function of transmitting the beam having the wavelengths of 1310 nm and reflecting the beam having the wavelengths of 1270 nm, while the second optical splitter 4118 has a function of isolating the beam having the wavelengths of 1490 nm, 1577 nm, etc., and the third optical splitter 4117 has a function of transmitting the beam having the wavelength of 1270 nm.

In some embodiments, a reception optical axis of the second light reception assembly 450 is perpendicular to the circuit board 300. In this case, if a reception optical axis of the first light reception assembly 440 is also perpendicular to the circuit board 300, it is necessary to further provide a fourth optical splitter configured to reflect a reflected reception beam from the second optical splitter 4118 again such that the reception beam reflected by the fourth optical splitter comes onto the third optical splitter 4117 for transmission. In this way, four optical splitters are used to split the two path of reception beams, which causes a large space to be taken up and does not facilitate obtaining a compact design of the first tubular shell 410.

In order to facilitate obtaining the compact design of the first tubular shell 410, the reception optical axis of the first light reception assembly 440 may be inclinedly disposed, and the third optical splitter 4117 may also be inclinedly disposed at a preset angle, such that the reflected reception beam from the second optical splitter 4118 may directly pass through the third optical splitter 4117 and come into the inclined first light reception assembly 440.

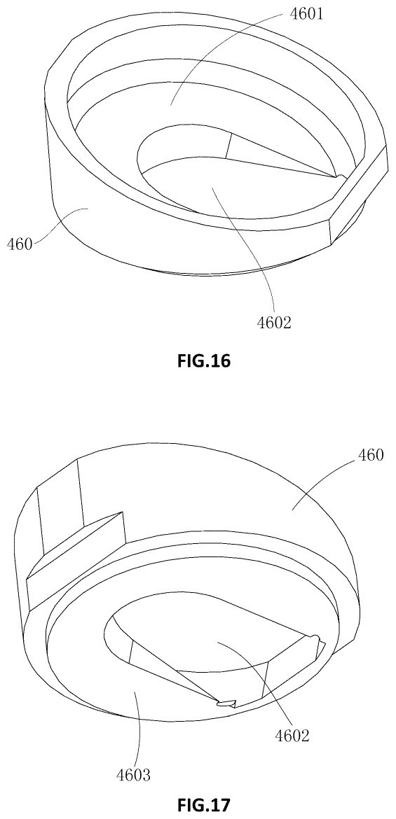

FIG. 16 is a structural schematic diagram illustrating a bracket of an optical module according to some embodiments, and FIG. 17 is a structural schematic diagram illustrating, from another angle, the bracket of the optical module according to some embodiments. As shown in FIGS. 16 and 17, in order to arrange the first light reception assembly 440 inclinedly, a bracket 460 is disposed at the first reception light port 4105. The bracket 460 includes a mounting recess and an insertion surface 4603. The insertion surface 4603 is inserted into the first reception light port 4105, and the insertion surface 4603 is fixedly connected to the inner wall of the first reception light port 4105, to fix the bracket 460 at the first reception light port 4105.

The mounting recess includes a mounting surface 4601, and an end of the mounting recess facing away from the insertion surface 4603 is provided with an opening, which is opposite to the mounting surface 4601. The mounting surface 4601 is inclined, and a distance between the mounting surface 4601 and the central axis of the first tubular shell 410 gradually decreases in the beam emission direction, that is, an inclination direction of the mounting surface 4601 is the same as that of the third optical splitter 4117.

In some embodiments, an angle equivalent to the fifth angle γ is formed between the mounting surface 4601 and the emission optical axis inside the first tubular shell 410. That is, the angle formed between the mounting surface 4601 and the emission optical axis and the angle between the third optical splitter 4117 and the emission optical axis are the same. Therefore, the mounting surface 4601 is parallel to the third optical splitter 4117.

The mounting surface 4601 is provided therein with a light hole 4602 which runs through the mounting surface 4601 and the insertion surface 4603. In this way, the light hole 4602 is arranged so as to correspond with the first reception light port 4105, and the first reception beam transmitted through the third optical splitter 4117 comes into the light hole 4602 through the first reception light port 4105.

The first light reception assembly 440 is inserted into the mounting recess, such that an outer wall of the first light reception assembly 440 is fixedly connected to the sidewall of the mounting recess and the mounting surface 4601. In this way, the first light reception assembly 440 is inclinedly disposed on the first tubular shell 410 via the bracket 460, and the first reception beam transmitted through the third optical splitter 4117 sequentially passes through the first reception light port 4105 and the light hole 4602 and comes into the first light reception assembly 440.

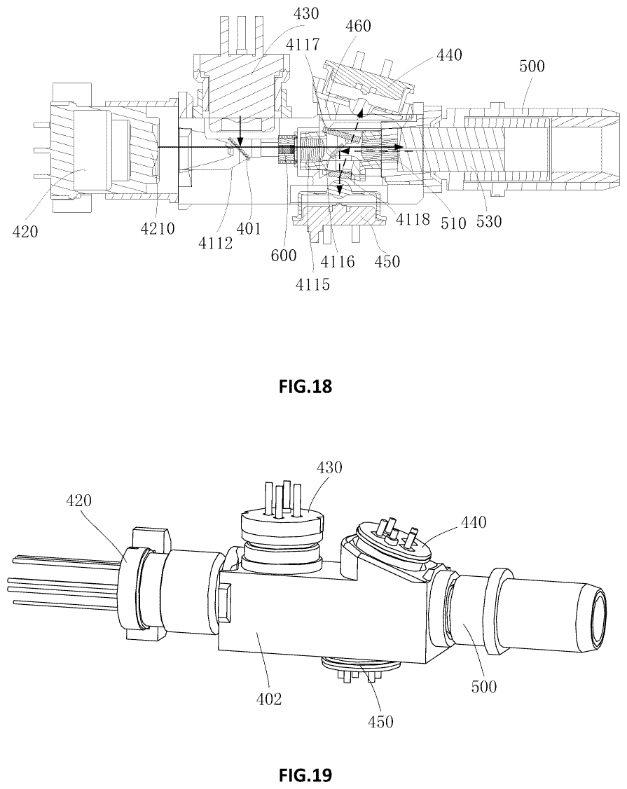

FIG. 18 is a structural schematic diagram of an optical transceiver component of an optical module according to some embodiments. As shown in FIG. 18, the collimating lens 4115 is mounted in the section of the light hole in the first connecting portion 4704 of the support frame 4710, and then the first optical splitter 4116 may be mounted on the first support surface 4701, the second optical splitter 4118 is mounted on the third support surface 4707, and the third optical splitter 4117 on the second stop surface 4703 and the second support surface 4702, thereby finishing the assembling of the light splitting assembly 470. Then the assembled light splitting assembly 470 is mounted in the third inner cavity 4114 of the first tubular shell 410. Then, the fiber adapter 500 disposed with the converging lens 510 is inserted into the third inner cavity 4114 through the integrated emission and reception light port 4107, with the converging lens 510 being inserted into the section of the light hole in the second connecting portion 4705 of the support frame 4710, such that the support frame 4710 and the fiber adapter 500 are fixedly connected to the first tubular shell 410. Then, the optical element 401 may be mounted on the support platform 4111 within the first inner cavity 4110, such that the central axes of the optical element 401, the collimating lens 4115, the first optical splitter 4116 and the converging lens 510 are on the same straight line. Besides, the isolator 600 is mounted in the second inner cavity 4113. Thus, the assembly of the optical element 401, the isolator 600, and the light splitting assembly 470 in the first tubular shell 410 is completed.

After completing the assembly of the first tubular shell 410, optical element 401, isolator 600 and light splitting assembly 470, the first light emission assembly 420 is laser welded to the first lateral side 4101 of the first tubular shell 410 via the adjustable sleeve, such that the first emission beam emitted by the first light emission assembly 420 comes into the first inner cavity 4110 through the first incident light port 4102 formed in the first lateral side 4101. Then, the second light emission assembly 430 is inserted into the first tubular shell 410 through the second incident light port 4104, and the second light reception assembly 450 is inserted into the first tubular shell 410 through the second reception light port 4109. Then, the bracket 460 is inserted into the first tubular shell 410 through the first reception light port 4105, and the first light reception assembly 440 is fixed in the mounting recess of the bracket 460. In this way, the assembly of the optical transceiver component 400 is completed.

After completing the assembly of the optical transceiver component 400, the first emission beam emitted by the first light emission assembly 420 sequentially passes through the optical element 401 and the isolator 600. The first emission beam transmitted through the isolator 600 is then converted into a parallel beam via the collimating lens 4115. The parallel beam passes through the first optical splitter 4116 and is incident, through the converging lens 510, into the optical fiber 530 disposed inside the fiber adapter 500, achieving the emission of the first emission beam.

The second emission beam emitted by the second light emission assembly 430 is reflected by the optical element 401. The second emission beam, after being reflected, passes through the isolator 600, and the second emission beam transmitted through the isolator 600 is converted into a parallel beam by the collimating lens 4115. The parallel beam passes through the first optical splitter 4116 and is incident, via the converging lens 510, into the optical fiber 530 disposed inside the fiber adapter 500, achieving the emission of the second emission beam.

In some embodiments, the first and second emission beams can be combined at the optical element 401, that is, the second emission beam is reflected at the optical element 401, and the reflected second emission beam is combined with the first emission beam transmitted through the optical element 401. The combined beam passes through the isolator 600, and after transmitted through the isolator 600, is converted into a parallel beam through the collimating lens 4115. The parallel beam passes through the first optical splitter 4116, and is incident, via the converging lens 510, into the optical fiber 530 disposed inside the fiber adapter 500, achieving the emission of both the first and second emission beams.

The first and second reception beams transported from the fiber adapter 500 are converted into a first parallel reception beam and a second parallel reception beam via the converging lens 510. The first and second parallel reception beams are reflected to the second optical splitter 4118 via the first optical splitter 4116, and the reflected second parallel reception beam directly pass through the second optical splitter 4118 and come into the second light reception assembly 450, achieving the reception of the second reception beam.

The reflected first parallel reception beam is reflected again at the second optical splitter 4118, and the re-reflected first parallel reception beam directly passes through the third optical splitter 4117 and comes into the first light reception assembly 440, achieving the reception of the first reception beam.

In some embodiments, the first and second reception beams transported by the fiber adapter 500 may be separate beams of different wavelengths or a combination beam containing the first and second reception beams.

In some embodiments, the first reception beam transported by the fiber adapter 500 is a reception light having a wavelength of 1270±10 nm, and the second reception beam is a reception light having a wavelength of 1310±20 nm, that is, the first reception beam may comprise a light having a wavelength of 1280 nm, and the second reception beam may comprise a light having a wavelength of 1290 nm, such that the first reception beam and the second reception beam have a small difference in wavelengths. Through the splitting effect of the first optical splitter 4116, the second optical splitter 4118 and the third optical splitter 4117 of the present disclosure, the first and second reception beams with the smaller wavelength difference can be divided, achieving a dense wavelength division function.

In this disclosure, a light path system including three lenses (coupling lens 4210 in the first light emission assembly 420, collimating lens 4115 in the first tubular shell 410, and converging lens 510 in the fiber adapter 500) and a light path design of converting converged light into parallel light are adopted, which improves the coupling efficiency of the optical transceiver component 400. The light splitting design is innovative and can achieve a dense wavelength division with a difference of no more than 6 nm, and, compared with other solutions in the art, it can better meet the wavelength division requirements of a protocol on Com-PON products at lower costs. This special light path design allows achieving dual-path emission and dual-path reception with the best filter sheets and minimal insertion loss.

In the optical module according to some embodiments, the collimating lens 4115 in the first tubular shell 410 and the converging lens 510 in the fiber adapter 500 are coupled in a passive coupling way. The collimating lens 4115 is directly assembled in the section of the light hole in the first connecting portion 4704, the converging lens 510 is directly assembled in the mounting hole of the connecting sleeve 520, and the converging lens 510 is inserted into the section of the light hole in the second connecting portion 4705. In order to improve the coupling of the emission light path and the reception light path with the fiber adapter 500 inside the first tubular shell 410, high mounting accuracy is required for the collimating lens 4115 and the converging lens 510.

The above assembly method has high requirements for the position of each component inside the first tubular shell 410, which affects the processing efficiency of the first tubular shell 410. Therefore, it is possible to improve the coupling way of the collimating lens 4115 and the converging lens 510 to reduce the requirements for the position of each component inside the first tubular shell 410 for assembling them.

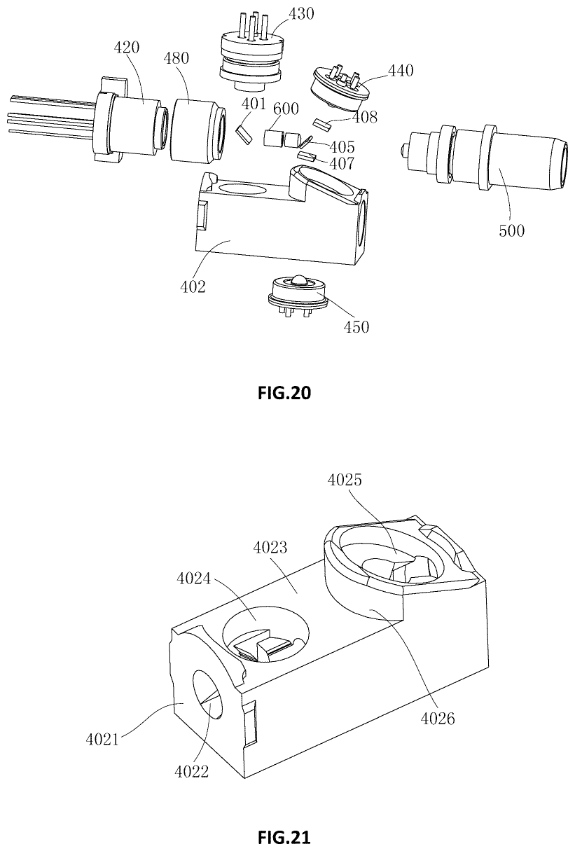

FIG. 19 is a structural schematic diagram illustrating another optical transceiver component of an optical module according to some embodiments, and FIG. 20 is an exploded schematic diagram of said another optical transceiver component of the optical module according to some embodiments. As shown in FIGS. 19 and 20, the optical transceiver component 400 according to some embodiments may include a second tubular shell 402, a light emission assembly, and a light reception assembly. The second tubular shell 402 includes an incident light port, an integrated emission and reception light port and a reception light port. The light emission assembly is connected to the second tubular shell 402 via the incident light port, the light reception assembly is connected to the second tubular shell 402 via the reception light port, and the fiber adapter 500 is connected to the second tubular shell 402 via the integrated emission and reception light port. In this way, an emission beam emitted by the light emission assembly can be incident into the second tubular shell 402 through the incident light port, and then passed through the second tubular shell 402 and is coupled to the fiber adapter 500 through the integrated emission and reception light port, achieving emission of light. A reception beam transported from the fiber adapter 500 comes into the second tubular housing 402 through the integrated emission and reception light port, and then passed through the second tubular shell 402 and is transported to the light reception assembly through the reception light port, achieving reception of light.

In some embodiments, the optical transceiver component 400 may only include one light emission assembly and one light reception assembly, and the second tubular shell 402 may only include one incident light port, one integrated emission and reception light port and one reception light port. The one light emission assembly is connected to the second tubular shell 402 through the incident light port, the one light reception assembly is connected to the second tubular shell 402 through the reception light port, and the fiber adapter 500 is connected to the second tubular shell 402 through the integrated emission and reception light port, thereby achieving one-path light emission and one-path light reception for the optical transceiver component 400.

In some embodiments, the optical transceiver component 400 may include two light emission assemblies and two light reception assemblies, and the second tubular shell 402 may include two incident light ports, two reception light ports and one integrated emission and reception light port. That is, the optical transceiver component 400 includes a first light emission assembly 420, a second light emission assembly 430, a first light reception assembly 440 and a second light reception assembly 450, and the second tubular shell 402 includes a first incident light port, a second incident light port, a first reception light port, a second reception light port and an integrated emission and reception light port. The first light emission assembly 420 is connected to the second tubular shell 402 via the first incident light port, the second light emission assembly 430 is connected to the second tubular shell 402 via the second incident light port, the first light reception assembly 440 is connected to the second tubular shell 402 via the first reception light port, the second light reception assembly 450 is connected to the second tubular shell 402 via the second reception light port, and the fiber adapter 500 is connected to the second tubular shell 402 via the integrated emission and reception light port.

The first incident light port is located in a left side of the second tubular shell 402, the second incident light port is located in an upper side of the second tubular shell 402, the first reception light port is located in the upper side of the second tubular shell 402, the second reception light port is located in a lower side of the second tubular shell 402, and the integrated emission and reception light port is located in a right side of the second tubular shell 402. That is, the first incident light port is disposed opposite to the integrated emission and reception light port, the second incident light port and the first reception light port are disposed on the same side of the second tubular shell 402, and the first reception light port is disposed opposite to the second reception light port.

An emission direction of an emission beam emitted by the first light emission assembly 420 is in the same direction as a beam reception direction of the fiber adapter 500. That is, the emission direction of the first light emission assembly 420 is parallel to the circuit board 300, and the beam reception direction of the fiber adapter 500 is also parallel to the circuit board 300. Therefore, the emission beam emitted by the first light emission assembly 420 is incident into the second tubular shell 402 via the first incident light port, which directly passes through the second tubular shell 402 and is coupled into the fiber adapter 500, achieving emission of one path of light.

In some embodiments, an light exiting end of the first light emission assembly 420 is provided with a coupling lens. Laser beam emitted by a laser disposed inside the first light emission assembly 420 is converted into a converged beam via the coupling lens, and the converged beam comes into the second tubular shell 402 via the first incident light port.

In some embodiments, a first emission beam emitted by the first light emission assembly 420 is transported in a direction of a central axis of the integrated emission and reception light port, such that the first emission beam passes through the second tubular shell 402 and into the fiber adapter 500. It should be noted that the central axis of the integrated emission and reception light port refers to an axis that passes through the center of the integrated emission and reception light port and is perpendicular to a plane where the integrated emission and reception light port is located.

An emission direction of an emission beam emitted by the second light emission assembly 430 differs from the beam reception direction of the fiber adapter 500. That is, the emission direction of the second light emission assembly 430 is perpendicular to the circuit board 300, and the beam reception direction of the fiber adapter 500 is parallel to the circuit board 300. Therefore, it is desirable to reflect the emission beam from the second light emission assembly 430 via the first tubular shell 410, such that a reflected emission beam has an emission direction that is same as the beam reception direction of the fiber adapter 500. Therefore, the emission beam emitted by the second light emission assembly 430 comes into the first tubular shell 410 via the second incident light port, and the reflected emission beam from the second tubular shell 402 is coupled to the fiber adapter 500, achieving another path of light emission.

In some embodiments, a second emission beam emitted by the second light emission assembly 430 is reflected via the second tubular shell 402, the reflected second emission beam is transported in the direction of the central axis of the integrated emission and reception light port, such that the reflected second emission beam passes through the second tubular shell 402 and comes into the fiber adapter 500.

In some embodiments, the second tubular shell 402 is provided therein with an optical element 401 at an intersection of an emission light path of the first light emission assembly 420 and an emission light path of the second light emission assembly 430. That is, the optical element 401 is located in beam emission directions of the first light emission assembly 420 and of the second light emission assembly 430.

The optical element 401 has functions transmitting the first emission beam and reflecting the second emission beam. The first emission beam and the reflected second emission beam can be combined via the optical element 401, and a combined beam is coupled to the fiber adapter 500. In this way, the first emission beam emitted by the first light emission assembly 420 can directly pass through the optical element 401, and the second emission beam emitted by the second light emission assembly 430 is reflected at the optical element 401, and the reflected second emission beam has the same emission direction as the first emission beam. Therefore, the first emission beam and the reflected second emission beam are combined at the optical element 401.

The optical element 401 has a transmission surface and a reflection surface, and the transmission surface is disposed opposite to the first light emission assembly 420, such that the first emission beam emitted by the first light emission assembly 420 directly passes through the optical element 401 via the transmission surface; the reflection surface is disposed opposite to the second light emission assembly 430 such that the second emission beam emitted by the second light emission assembly 430 is reflected via the reflection surface, and the reflected second emission beam is transported in the emission direction of the first emission beam, and the reflected second emission beam is combined with the first emission beam at the reflection surface.

In some embodiments, the optical element 401 may be a filter sheet, a prism attached with a filter sheet or a filter film, or other structures, as long as the optical element 401 has the functions of transmitting the first emission beam and reflecting the second emission beam.

In some embodiments, the optical element 401 is a filter sheet. The filter sheet has a smaller volume and occupies a smaller space and thus facilitates obtaining a compact design of the optical transceiver component 400.

In some embodiments, the first emission beam may have a wavelength of 1270 nm, 1310 nm, 1490 nm, or 1577 nm, etc., and the second emission beam may have a wavelength of 1270 nm, 1310 nm, 1490 nm, or 1577 nm, etc.

In some embodiments, the wavelength of the first emission beam is 1577 nm, and the wavelength of the second emission beam is 1490 nm. Accordingly, the optical element 401 has the functions of transmitting a beam having the wavelength of 1577 nm and reflecting a beam having the wavelength of 1490 nm. The first emission beam of 1577 nm emitted by the first light emission assembly 420 directly passes through the optical element 401, and the second emission beam of 1490 nm emitted by the second light emission assembly 430 is reflected at the optical element 401, and the reflected second emission beam is combined with the first emission beam and then is transported to the fiber adapter 500.

Since a beam reception direction in which the first light reception assembly 440 receives a beam and the beam reception direction of the fiber adapter 500 are in different directions, that is, the beam reception direction of the first light reception assembly 440 is not parallel to the circuit board 300, while the beam reception direction of the fiber adapter 500 is parallel to the circuit board 300, it is desirable to reflect the reception beam of the fiber adapter 500 via the second tubular shell 402 such that the reflected reception beam is in the same direction as the reception direction of the first light reception assembly 440. In this way, external beam received by the fiber adapter 500 comes into the second tubular shell 402 via the integrated emission and reception light port, which is reflected by the second tubular shell 402, and the reflected reception beam is coupled to the first light reception assembly 440, achieving reception of one path of light.

Since a beam reception direction in which the second light reception assembly 450 receives a beam and the beam reception direction of the fiber adapter 500 are in different directions, that is, the beam reception direction of the second light reception assembly 450 is perpendicular to the circuit board 300, while the beam reception direction of the fiber adapter 500 is parallel to the circuit board 300, it is desirable to reflect the reception beam of the fiber adapter 500 via the second tubular shell 402, such that the reflected reception beam is in the same direction as the reception direction of the second light reception assembly 450. In this way, an external beam received by the fiber adapter 500 comes into the second tubular shell 402 via the integrated emission and reception light port, which is reflected by the second tubular shell 402, and the reflected reception beam from the second tubular shell is coupled to the second light reception assembly 450, achieving reception of another path of light.

The second tubular shell 402 is provided therein with a fourth optical splitter 405, a fifth optical splitter 407 and a sixth optical splitter 408. The fourth optical splitter 405 is arranged in the reception direction of the fiber adapter 500, and is configured to reflect a first and second reception beams transported by the fiber adapter 500. The fifth optical splitter 407 is arranged in correspondence to the second light reception assembly 450 and is configured to transmit a reflected second reception beam and reflect a reflected first reception again, such that a transmitted second reception beam is incident into the second light reception assembly 450. The sixth optical splitter 408 is arranged in correspondence to the first light reception assembly 440, and is configured to transmit the reflected first reception beam from the fifth optical splitter 407, such that a transmitted first reception beam is incident into the first light reception assembly 440.

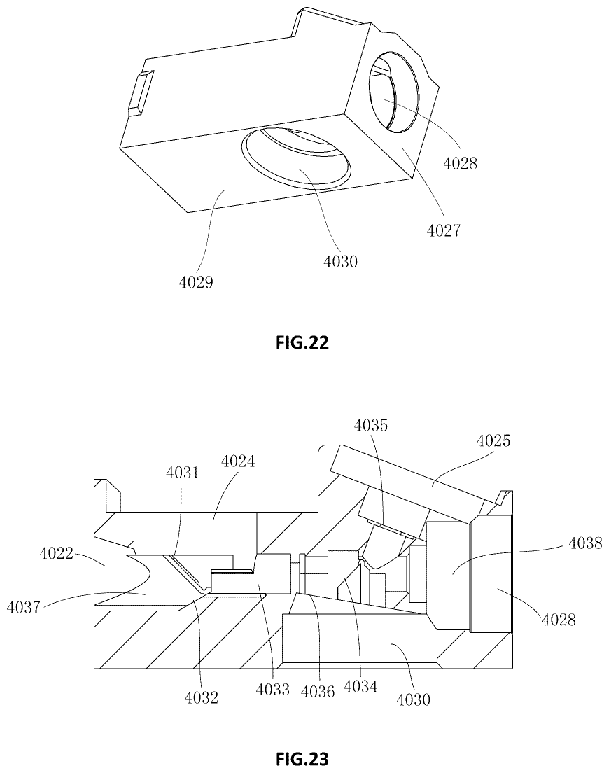

FIG. 21 is a structural schematic diagram of another tubular shell of an optical module according to some embodiments, FIG. 22 is a structural schematic view illustrating, from another angle, said another tubular shell of the optical module according to some embodiments, and FIG. 23 is a sectional schematic view of said another tubular shell of the optical module according to some embodiments. As shown in FIGS. 21, 22, and 23, the second tubular shell 402 includes a first surface 4021, a second surface 4023, a third surface 4027 and a fourth surface 4029. The first surface 4021 is disposed opposite to the third surface 4027, and the second surface 4023 is disposed opposite to the fourth surface 4029. Two ends of the second surface 4023 are respectively connected to the first surface 4021 and the third surface 4027.

The first surface 4021 is provided therein with a first light inlet 4022, which is communicated with an inner cavity of the second tubular shell 402. The first light emission assembly 420 is connected to the second tubular shell 402 at the first surface 4021, such that the first emission beam emitted by the first light emission assembly 420 is incident into the second tubular shell 402 via the first light inlet 4022. In some embodiments, the first light emission assembly 420 may be fixedly connected to the first surface 4021 via an adjustable sleeve 480.

The second surface 4023 is provided therein with a second light inlet 4024 which is communicated with the inner cavity of the second tubular shell 402. The second light emission assembly 430 is connected to the second tubular shell 402 via the second light inlet 4024, such that the second emission beam emitted by the second light emission assembly 430 is incident into the second tubular shell 402 via the second light inlet 4024.

The second surface 4023 is also provided therein with a first light outlet 4025 which is communicated with the inner cavity of the second tubular shell 402. The first light reception assembly 440 is connected to the second tubular shell 402 via the first light outlet 4025, such that the first reception beam received through the second tubular shell 402 is incident into the first light reception assembly 440 via the first light outlet 4025.

In some embodiments, a fixing bracket 4026 may be protrusively disposed on the second surface 4023, and an inclined mounting hole is provided in the fixing bracket 4026. The mounting hole is communicated with the inner cavity of the second tubular shell 402, and the first light reception assembly 440 is inserted into the mounting hole, such that the first light reception assembly 440 is inclinedly fixed to the second tubular shell 402.

In some embodiments, the fixing bracket 4026 is integrated with the second tubular shell 402, and the mounting hole formed in the fixing bracket 4026 is also the first light outlet 4025 of the second tubular shell 402.

The third surface 4027 is provided therein with an emission and reception light port 4028 which is communicated with the inner cavity of the second tubular shell 402. The fiber adapter 500 is connected to the second tubular shell 402 via the emission and reception light port 4028, such that the reception beam transported by the fiber adapter 500 comes into the second tubular shell 402 via the emission and reception light port 4028. In some embodiments, the fiber adapter 500 is inserted into the second tubular shell 402 via the emission and reception light port 4028, to achieve a fixed connection between the fiber adapter 500 and the second tubular shell 402.

The fourth surface 4029 is provided therein with a second light outlet 4030, which is communicated with the inner cavity of the second tubular shell 402. The second light reception assembly 450 is connected to the second tubular shell 402 at the fourth surface 4029, such that the second reception beam received through the second tubular shell 402 is incident into the second light reception assembly 450 via the second light outlet 4030. In some embodiments, the second light reception assembly 450 can be inserted into the second light outlet 4030, with an outer wall of the second light reception assembly 450 being adhered and fixed to an inner wall of the second light outlet 4030.

The second tubular shell 402 is provided therein with a first cavity 4037, a second cavity 4033 and a third cavity 4038. The first light inlet 4022 and the second light inlet 4024 are communicated with the first cavity 4037, and the optical element 401 is disposed within the first cavity 4037. The first cavity 4037 is communicated with the third cavity 4038 via the second cavity 4033, the first light outlet 4025, the second light outlet 4030 and the emission and reception light port 4028 are communicated with the third cavity 4038, and the fourth optical splitter 405, the fifth optical splitter 407 and the sixth optical splitter 408 are disposed within the third cavity 4038.

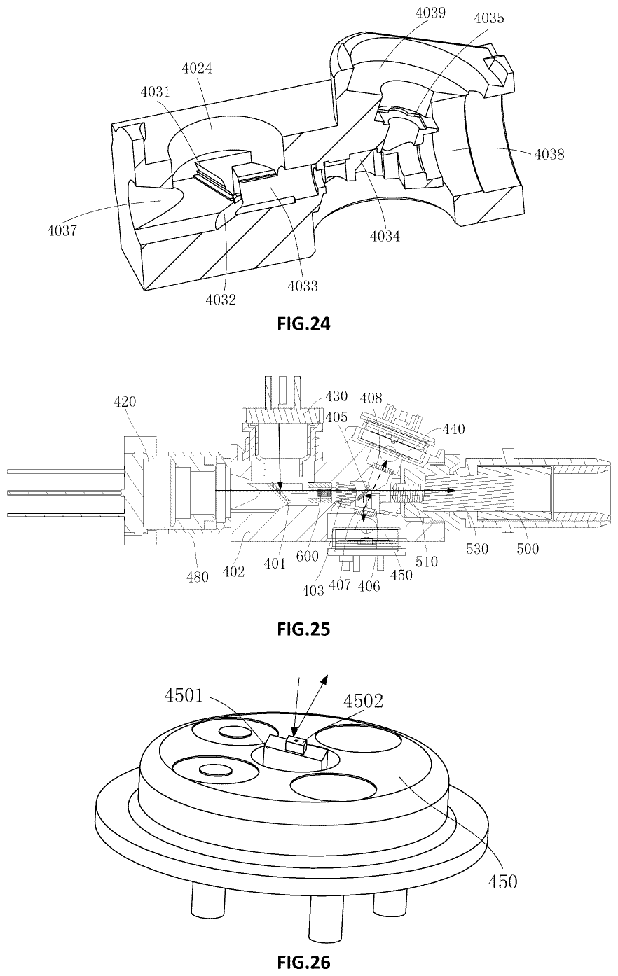

FIG. 24 is a sectional schematic view illustrating, from another angle, the second tubular shell of the optical module according to some embodiments. As shown in FIG. 24, the first cavity 4037 is provided with a support part 4031, which is inclinedly disposed, and the support platform 4031 is inclined from top to bottom in a direction from the first light inlet 4022 towards the second cavity 4033, that is, a distance between the support part 4031 and the second light inlet 4024 gradually increases in the emission direction of the first emission beam, such that a first angle is formed between the support part 4031 and an emission optical axis in the second tubular shell. In some embodiments, the first angle is 45 degrees.

A transmission surface of the optical element 401 is adhered to the support part 4031, such that there is also the first angle between the optical element 401 and the emission optical axis. The second emission beam emitted by the second light emission assembly 430 is reflected on the reflection surface of the optical element 401, and the reflected second emission beam has the same emission direction as the first emission beam.

In some embodiments, in order to enable the first emission beam emitted by the first light emission assembly 420 to easily pass through the optical element 401, the support part 4031 is provided therein with a light hole, which is communicated with the first inner cavity 4037. In this way, the first emission beam emitted by the first light emission assembly 420 passes through the first cavity 4037 and the light hole, and comes onto the optical element 401, and the first emission beam directly passes through the optical element 401.

In some embodiments, the light hole in the support part 4031 may be an opening or a platform area made of transparent material, as long as the first emission beam emitted by the first light emission assembly 420 can be incident onto the optical element 401 through the light hole.

In some embodiments, when the first emission beam is transmitted through the optical element 401, most (about 95%) of the first emission beam directly passes through the optical element 401, but there is still a portion (about 5%) of the first emission beam that may be reflected at the transmission surface of the optical element 401, and the reflected first emission beam may be reflected again at the inner wall of the first cavity 4037, the re-reflected first emission beam may come into the second light emission assembly 430 through the second incident light port 4024, causing an interference of the reflected light on the second emission beam.

In order to avoid the interference of the reflected first emission beam on the second emission beam, a slope 4032 is disposed on the inner wall of the first cavity 4031. The slope 4032 is located below the support part 4031, and a distance between the slope 4032 and the second light inlet 4024 gradually decreases in the emission direction of the first emission beam. In this way, after a portion of the first emission beam is reflected at the transmission surface of the optical element 401, the reflected portion of the first emission beam is reflected again on the slope 4032. Due to the provision of the slope 4032, the re-reflected portion of the first emission beam diverge outward, which prevents the re-reflected portion of first emission beam from being incident into the second light inlet 4024, and thus effectively reduces the interference of the reflected light on the second emission beam.

In order to avoid the portion of the first emission beam reflected on the slope 4032 from coming into the second incident light port 4024, a second angle is formed between the slope 4032 and the emission optical axis. In some embodiments, the second angle is between 20° and 50°.

The first emission beam emitted by the first light emission assembly 420 passes through the optical element 401 and then is transported to the fiber adapter 500. Due to changes in mediums and potential reflection occurring during light propagations at interfaces between different mediums, when the first emission beam passes through the second cavity 4033 and the third cavity 4038 and comes onto an end face of a fiber inside the fiber adapter 500, most of the first emission beam directly come into the fiber adapter 500 through the end face of the fiber, while a small portion of the first emission beam may be reflected at the end face of the fiber.

The reflected portion of the first emission beam may backtrack to the first light emission assembly 420, affecting the emission performance of the first light emission assembly 420.

In order to avoid the reflected portion of the first emission beam from backtracking to the first light emission assembly 420, it is possible to provide an isolator within the second cavity 4033. The first emission beam transmitted through the optical element 401 directly passes through the isolator and comes into the fiber adapter 500. The isolator can isolate the portion of the first emission beam reflected by the end face of the fiber of the fiber adapter 500 to prevent the reflected portion of the first emission beam from returning to the first light emission assembly 420, ensuring the emission performance of the first light emission assembly 420.

In some embodiments, with a coupling lens arranged at a light exiting end of the first light emission assembly 420, the first emission beam emitted by the first light emission assembly 420 is converted into a converged beam. The converged beam has a smallest facula at the focal point, and thus the isolator can be placed at a position where the focal point of the first emission beam is located. In this case, a required size of the isolator is minimal, ensuring that an aperture of the second cavity 4033 required for the isolator is minimal, which facilitates obtaining a compact design of the second tubular shell 402.

The third cavity 4038 is provided therein with a first mounting platform 4034, a second mounting platform 4036 and a third mounting platform 4035. The first mounting platform 4034 is inclined, that is, a distance between the first mounting platform 4034 and the emission and reception light port 4028 gradually decreases in the emission direction of the first emission beam (from left to right).

In some embodiments, the first mounting platform 4034 is provided therein with a light hole, which is communicated with the third cavity 4038. In this way, the first emission beam transmitted through the optical element 401 passes through the light hole and comes into the fiber adapter 500, and the second emission beam reflected by the optical element 401 passes through the light hole and comes into the fiber adapter 500.

The fourth optical splitter 405 is adhered, at a side thereof, to the first mounting platform 4034, and a sixth angle is formed between the fourth optical splitter 405 and the emission optical axis. The fourth optical splitter 405 has a function of reflecting the first reception beam and the second reception beam, and is configured to reflect the first reception beam and the second reception beam transported by the fiber adapter 500. In some embodiments, the sixth angle is between 40° and 50°.

In some embodiments, the fourth optical splitter 405 is provided with a reflection surface on a portion of the fourth optical splitter exposed through the light hole. When the first and second reception beams transported by the fiber adapter 500 come onto the reflection surface of the fourth optical splitter 405, the first and second reception beams are reflected at the reflection surface of the fourth optical splitter 405.

The second mounting platform 4036 is located below the first mounting platform 4034, and the second mounting platform 4036 is inclined, that is, a distance between the second mounting platform 4036 and the second light outlet 4030 gradually decreases in the emission direction of the first emission beam (from left to right). The second mounting platform 4036 is provided with a through hole, and the third cavity 4038 is communicated with the second light outlet 4030 via this through hole.

The fifth optical splitter 407 is adhered, at a side thereof, to the second mounting platform 4036, and a seventh angle is formed between the fifth optical splitter 407 and the emission optical axis. The fifth optical splitter 407 has a function of reflecting the first reception beam and transmitting the second reception beam, and is configured to transmit the second reception beam reflected by the fourth optical splitter 405 and reflect the first reception beam reflected by the fourth optical splitter 405 again. In some embodiments, the seventh angle is between 6° and 20°.

In some embodiments, the fifth optical splitter 407 is provided with a transmission-reflection surface on a side (lower surface) thereof facing the second light outlet 4030. Reflected first and second reception beams reflected by the fourth optical splitter 405 comes onto the fifth optical splitter 407, and the reflected first reception beam is reflected again on the transmission-reflection surface. The reflected second reception beam from the fourth optical splitter 405 directly passes through the transmission-reflection surface, and, after passing through the fifth optical splitter 407, comes into the second light reception assembly 450 via the second light outlet 4030.

If the transmission-reflection surface is provided on the upper surface of the fifth optical splitter 407, it is necessary to adhere the lower surface of the fifth optical splitter 407 to the second mounting platform 4036. In this case, it is also necessary to place the fifth optical splitter 407 in the through hole of the second mounting platform 4036, which would increase a size of the third cavity 4038. On the contrary, when the transmission-reflection surface is provided on the lower surface of the fifth optical splitter 407, only one through hole needs to be provided to allow the reception beam to come onto the fifth optical splitter 407, thereby effectively reducing the size of the second tubular shell 402 and facilitating obtaining a compact design of the second tubular shell 402.

In some embodiments, in order to facilitate the mounting of the fifth optical splitter 407 on the second mounting platform 4036, the third chamber 4038 may also be provided with a fixing member, which is inclinedly mounted on the second mounting platform 4036 and has a light hole. The fifth optical splitter 407 is installed on a lower surface of the fixing member and is arranged in correspondence to the light hole, thereby reducing a size of the fifth optical splitter 407.

In some embodiments, the fixing member may be a disc with a light hole at a center of the disc, a side of the disc is adhered to the second mounting platform 4036, and the fifth optical splitter 407 is mounted at the center of the disc.

The third mounting platform 4035 is located diagonally above the first mounting platform 4034, and the third mounting platform 4035 is inclined, that is, a distance between the third mounting platform 4035 and the second light outlet 4030 gradually decreases in the emission direction of the first emission beam (from left to right). The third mounting platform 4035 is provided with a light hole, via which the third cavity 4038 is communicated with the first light outlet 4025.

The sixth optical splitter 408 is adhered, at a side thereof, to the third mounting platform 4035, such that an eighth angle is formed between the sixth optical splitter 408 and the emission optical axis. The sixth optical splitter 408 has a function of transmitting the first reception beam and is configured to transmit the re-reflected first reception beam from the fifth optical splitter 407. In some embodiments, the eighth angle is between 10° and 22°.

In some embodiments, the six optical splitter 408 is provided with a transmission surface on a side (lower surface) thereof facing the fifth optical splitter 407. The first reception beam reflected by the fifth optical splitter 407 directly passes through the transmission surface of the sixth optical splitter 408, and the transmitted first received beam transmitted through the sixth optical splitter 408 comes into the first light reception assembly 440 via the first light outlet 4025.

In some embodiments, the fixing bracket 4026 is provided with a mounting recess, which includes a fourth mounting platform 4039. A through hole is provided in the fourth mounting platform 4039 to communicate with the third mounting platform 4035. The fourth mounting platform 4039 is inclined, and a distance between the fourth mounting platform 4039 and a central axis of the second tubular shell 402 gradually decreases in the emission direction of the first emission beam, that is, an inclination direction of the fourth mounting platform 4039 is the same as that of the third mounting platform 4035.

The first light reception assembly 440 is inclinedly inserted into the mounting recess of the fixing bracket 4026. An outer surface of a cap of the first light reception assembly 440 is in contact with the fourth mounting platform 4039. An incident lens of the first light reception assembly 440 can be located in the through hole of the fourth mounting platform 4039. In this way, the first light reception assembly 440 is inclinedly disposed on the second tubular shell 402 via the mounting recess of the fixing bracket 4026.

An angle equivalent to the eight angle may be formed between the fourth mounting platform 4039 and the emission optical axis in the second tubular shell 402, that is, the angle between the fourth mounting platform 4039 and the emission optical axis may be the same as the angle between the third mounting platform 4035 and the emission optical axis, and the fourth mounting platform 4039 is arranged parallel to the third mounting platform 4035.

In some embodiments, the angle between the fourth mounting platform 4039 and the transmission optical axis may also differ from the angle between the third mounting platform 4035 and the transmission optical axis, with the angle formed between the fourth mounting platform 4039 and the third mounting platform 4035 being smaller. In some embodiments, the angle between the fourth mounting platform 4039 and the emission optical axis is 22°.

In some embodiments, the sixth angle between the fourth optical splitter 405 and the emission optical axis inside the second tubular shell 402 is 44°, the seventh angle between the fifth optical splitter 407 and the emission optical axis is 9.5°, and the eighth angle between the sixth optical splitter 408 and the emission optical axis is 21°. In this way, the first and second reception beams transported by the fiber adapter 500 are reflected to the fifth optical splitter 407 via the fourth optical splitter 405. The reflected second reception beam directly passes through the fifth optical splitter 407, the reflected first reception beam is reflected again at the fifth optical splitter 407, and the re-reflected first reception beam directly passes through the sixth optical splitter 408.

In some embodiments, the fourth optical splitter 405, the fifth optical splitter 407 and the sixth optical splitter 408 may be filter sheets, prisms attached with filter sheets or filter films, or other structures, which are not limited herein.

In some embodiments, the fourth optical splitter 405, the fifth optical splitter 407, and the sixth optical splitter 408 are all filter sheets. The filter sheet has a smaller volume and occupies smaller space, and thus facilitates obtaining a compact design of the second tubular shell 402.

The first reception beam may have a wavelength of 1270 nm, 1310 nm, 1490 nm, 1577 nm, etc., without specific limitations herein. Correspondingly, the second reception beam may have a wavelength of 1270 nm, 1310 nm, 1490 nm, or 1577 nm, etc., without specific limitations herein.

In some embodiments, the first reception beam has the wavelength of 1270 nm, and the second reception beam has the wavelength of 1310 nm. Therefore, the fourth optical splitter 405 has a function of reflecting a beam having a wavelength of 1270 nm and a beam having a wavelength of 1310 nm, the fifth optical splitter 407 has a function of transmitting the beam having the wavelength of 1310 nm and reflecting the beam having the wavelength of 1270 nm, while the fifth optical splitter 407 has a function of isolating the beam having the wavelengths of 1490 nm, 1577 nm, etc., and the sixth optical splitter 408 has a function of transmitting the beam having the wavelength of 1270 nm.

FIG. 25 is a structural schematic diagram illustrating said another optical transceiver component of an optical module according to some embodiments. As shown in FIG. 25, the fiber adapter 500 includes a connecting sleeve, an internal optical fiber 530, an outer sleeve and an inner sleeve. The connecting sleeve is fixedly connected, at one end thereof, to the outer sleeve, and, at the other end thereof, to the third surface 4027 of the second tubular shell 402. The inner sleeve is fixed to a sidewall of an inner cavity of the outer sleeve, and the inner optical fiber 530 is fixed in the inner cavity of the outer sleeve via the inner sleeve. The connecting sleeve is provided with therein a mounting hole, which is communicated with the inner cavity of the outer sleeve. A converging lens 510 is provided in the mounting hole in such a way that the converging lens 510 protrudes from the connecting sleeve and is inserted into the third cavity 4038 through the emission and reception light port 4028. In this way, the first and second reception beams transported by the optical fiber 530 disposed inside the fiber adapter 500 are converted into converged beams via the converging lens 510, and the converged beams comes onto the fourth optical splitter 405 through the third cavity 4038.

The third cavity 4038 is also provided therein with an assembling hole, and a first lens 403 is disposed in the assembling hole. The first lens 403 is located between the isolator 600 and the fourth optical splitter 405. The first lens 403 is a collimating lens configured to convert the first emission beam transmitted through the optical element 401 and the second emission beam reflected at the optical element 401 into parallel beams, respectively. The parallel beams directly pass through the fourth optical splitter 405 into the converging lens 510 where the parallel beams are converted into converged beams, and the converged beams converge into the internal fiber 530.

When assembling the optical transceiver component 400, the first lens 403 may be firstly inserted into the assembling hole of the third cavity 4038. Then, the fourth optical splitter 405 may be directly adhered to the first mounting platform 4034 in a passive adhering way, the fixing member 406 may be directly adhered to the second mounting platform 4036 in the passive adhering way, the fifth optical splitter 407 is fixed on the fixing member 406, and the sixth optical splitter 408 is directedly adhered to the third mounting platform 4035 in a passive adhering way. Then, the fiber adapter 500 mounted with the converging lens 510 is inserted into the third cavity 4038 through the emission and reception light port 4028, such that the first lens 403 is actively coupled with the converging lens 510.

In some embodiments, the first lens 403 is directly placed in the assembling hole of the third cavity 4038, and the converging lens 510 is inserted into the third cavity 4038 together with the fiber adapter 500. The first lens 403 is actively coupled with the converging lens 510. In this way, position and accuracy requirements of the first lens 403 in the third cavity 4038 are not high, which facilitates the assembly of the first lens 403.

After completing the assembly of the optical element 401, the isolator 600, the first lens 403, the fourth optical splitter 405, the fifth optical splitter 407 and the sixth optical splitter 408 in the second tubular shell 402, the first light emission assembly 420 is laser welded onto the first surface 4021 of the second tubular shell 402 by the adjustable sleeve, such that the first emission beam emitted by the first light emission assembly 420 comes into the first cavity 4037 through the first light inlet 4022. Then, the second light emission assembly 430 is inserted into the second tubular housing 402 via the second light inlet 4024. Then, the first light reception assembly 440 is connected to the second tubular shell 402 via the fixing bracket 4026, and the first light reception assembly 440 is fixedly connected to the second tubular shell 402 by an adhesive. Then, the second light reception assembly 450 is inserted into the second tubular shell 402 via the second light outlet 4030, and the second light reception assembly 450 is fixedly connected to the second tubular shell 402 by an adhesive. In this way, the assembly of the optical transceiver component 400 is completed.

After completing the assembly of the optical transceiver component 400, the first emission beam emitted by the first light emission assembly 420 sequentially passes through the optical element 401 and the isolator 600. The first emission beam transmitted through the isolator 600 is converted into a parallel beam via the first lens 403. The parallel beam passes through the fourth optical splitter 405 and comes into the internal optical fiber 530 of the fiber adapter 500 via the converging lens 510, achieving the emission of the first emission beam.

The second emission beam emitted by the second light emission assembly 430 is reflected by the optical element 401. The second emission beam which is reflected passes through the isolator 600, and the second emission beam transmitted through the isolator 600 is converted into a parallel beam via the first lens 403. The parallel beam passes through the fourth optical splitter 405 and comes into the optical fiber 530 disposed inside the fiber adapter 500 via the converging lens 510, achieving the emission of the second emission beam.

In some embodiments, the first and second emission beams can be combined at the optical element 401, that is, the second emission beam is reflected at the optical element 401, and the reflected second emission beam is combined with the first emission beam transmitted through the optical element 401. The combined beam passes through the isolator 600, and the combined beam transmitted through the isolator 600 is converted into a parallel beam via the first lens 403. The parallel beam passes through the fourth optical splitter 405, and comes into the internal optical fiber 530 of the fiber adapter 500 via the converging lens 510, simultaneously achieving the emission of the first and second emission beams.

The first and second reception beams transported through the fiber adapter 500 are converted into a first parallel reception beam and a second parallel reception beam via the converging lens 510. The first parallel reception beam and the second parallel reception beam are reflected to the fifth optical splitter 407 by the fourth optical splitter 405, and the reflected second parallel reception beam directly passes through the fifth optical splitter 407 and come into the second light reception assembly 450, achieving the reception of the second reception beam.

The reflected first parallel reception beam from the fourth optical splitter 405 is reflected again at the fifth optical splitter 407, and the re-reflected first reception beam directly passes through the sixth optical splitter 408 and comes into the first light reception assembly 440, achieving the reception of the first reception beam.

In some embodiments, the first and second reception beams transported by the fiber adapter 500 may be separate beams of different wavelengths or a combined beam containing the first and second reception beams.

In some embodiments, the first reception beam transported by the fiber adapter 500 is a reception light having a wavelength of 1270±10 nm, and the second reception beam is a reception light having a wavelength of 1310±20 nm, that is, the first reception beam may comprise a light having a wavelength of 1280 nm, and the second reception beam may comprise a light having a wavelength of 1290 nm, such that the first reception beam and the second reception beam have a small difference in wavelengths. Through the splitting effect of the fourth optical splitter 405, the fifth optical splitter 407 and the sixth optical splitter 408 of the present disclosure, the first and second reception beams with the smaller wavelength difference can be divided, achieving a dense wavelength division function.

In this disclosure, a light path system having three lenses (coupling lens in the first light emission assembly 420, first lens 403 in the second tubular shell 402, and converging lens 510 in the fiber adapter 500) and an light path design of converting converging light into parallel light are adopted, which improves the coupling efficiency of the optical transceiver component 400. The beam splitting design is innovative and can achieve dense wavelength division with a difference of no more than 6 nm, and, compared with other solutions in the art, it can better meet the wavelength division requirements of a protocol on Com-PON products at lower costs. This special light path design allows to achieve dual emission and dual reception with the best filter sheets and minimal insertion loss.

In some embodiments, when the first light reception assembly 440 receives the first reception beam transported through the tubular shell, and the second light reception assembly 450 receives the second reception beam transported through the tubular shell, reception return loss and responsiveness indexes are involved when the light reception assemblies receive the beams, and the reception return loss and responsiveness indexes keep in check and balance mutually.

FIG. 26 is a structural schematic diagram of a light reception assembly of an optical module according to some embodiments. As shown in FIG. 26, taking the second light reception assembly 450 as an example, the second light reception assembly 450 includes a TO tubular base, a carrier 4501 and a PD chip 4502. The carrier 4501 is disposed on the TO tubular base, and one end of the carrier 4501 facing away from a surface of the TO tubular base is provided with a slope. The slope is inclined downwards from left to right, that is, a distance between the slope and a central axis of the tubular shell gradually increases in the emission direction inside the tubular shell. In some embodiments, an angle between the slope and the emission optical axis is 12°.

The PD chip 4502 is disposed on the slope of the carrier 4501, such that the PD chip 4502 is inclinedly fixed on the TO tubular base. In this way, when the second reception beam passes through the optical splitters and comes onto the PD chip 4502, the PD chip 4502 is in a non-orthogonal design arrangement with the reception light path, and part of the reception beam is reflected at the PD chip 4502, but the reflected reception beam has no effect on the reception beam coming onto the PD chip 4502, greatly improving the reception return loss index and having little impact on the reception responsiveness index, achieving compatibility between the reception return loss and responsiveness indexes.

Finally, it should be noted that the foregoing embodiments are merely intended to describe the technical solutions of the present disclosure, and shall not be construed as limitations to this disclosure. Although the present disclosure is described in detail with reference to the foregoing embodiments, one of ordinary skills in the art may understand that modifications still may be made to the technical solutions disclosed in the foregoing embodiments, or equivalent replacements may be made to some of the technical features, and these modifications or equivalent replacements do not deviate the nature of corresponding technique solutions from the spirit and scope of the technique solutions of the embodiments of the present disclosure.

The above only describes some specific embodiments of this disclosure, but the protection scope of this disclosure is not limited thereto. Any changes or replacements envisaged by any person skilled in the art within the scope of the disclosed technology shall fall within the protection scope of this disclosure. Therefore, the protection scope of this disclosure shall be based on those defined by the claims.

What is claimed is:

1. An optical module, comprising:
a circuit board;
an optical transceiver component electrically connected to the circuit board; and
a fiber adapter connected to the optical transceiver component,
wherein, the optical transceiver component comprises:
a first tubular shell having an inner cavity and a first incident light port and a second incident light port, a first reception light port and a second reception light port, and an integrated emission and reception light port that are communicated with the inner cavity, wherein the fiber adapter is inserted into the inner cavity via the integrated emission and reception light port; the inner cavity is provided therein with an optical element and an inclined plane, the optical element being configured to transmit and reflect emission beams incident into the first tubular shell, and the inclined plane being located below the optical element and opposite to a transmission surface of the optical element, and being configured to re-reflect an emission beam reflected by the transmission surface such that the emission beam, after being re-reflected by the inclined plane, does not pass through the second incident light port;
a light splitting assembly disposed in the inner cavity of the first tubular shell downstream of the optical element in a beam emission direction inside the first tubular shell, and comprising a support frame and a first optical splitter, a second optical splitter and a third optical splitter disposed on the support frame, wherein the first optical splitter is configured to reflect multi-path reception beams transported from the fiber adapter; the second optical splitter is configured to split the multi-path reception beams reflected from the first optical splitter such that a first reception beam of the multi-path reception beams is directly transmitted through the second optical splitter, and a second reception beam of the multi-path reception beams is reflected again at the second optical splitter and then comes onto the third optical splitter; and the third optical splitter is configured such that the second reception beam re-reflected from the second optical splitter is transmitted through the third optical splitter;
a first light emission assembly connected to the first tubular shell at the first incident light port and configured to generate a first emission beam, and the first emission beam can pass through the optical element and be coupled to the fiber adapter after passing through the first optical splitter;
a second light emission assembly connected to the first tubular shell at the second incident light port and configured to generate a second emission beam, and the second emission beam can be reflected by the optical element and then be coupled to the fiber adapter after passing through the first optical splitter;
a first light reception assembly connected to the first tubular shell at the first reception light port and configured to receive the second reception beam transmitted through the third optical splitter; and
a second light reception assembly connected to the first tubular shell at the second light reception port and configured to receive the first reception beam transmitted through the second optical splitter, wherein the second light reception assembly is assembled on the first tubular shell perpendicular to a central axis of the first tubular shell;
a bracket disposed at the first reception light port and comprising a mounting surface and an insertion surface disposed opposite to each other, wherein the insertion surface is configured to be inserted in the first reception light port to fix the bracket to the first reception light port; the mounting surface is inclinedly disposed such that a distance between the mounting surface and the central axis of the first tubular shell gradually decreases in the beam emission direction inside the first tubular shell, and the first light reception assembly is assembled on the mounting surface and is thus inclinedly disposed relative to the central axis of the first tubular shell.

2. The optical module according to claim 1, wherein,
the inner cavity of the first tubular shell comprises a first inner cavity, a second inner cavity and a third inner cavity, wherein the first inner cavity is communicated with the third inner cavity through the second inner cavity, the first inner cavity is communicated with the first incident light port and the second incident light port, and the optical element is disposed in the first inner cavity; and
the third inner cavity is also communicated with the first reception light port, the second reception light port and the integrated emission and reception light port, and the light splitting assembly is disposed in the third inner cavity.

3. The optical module according to claim 2, wherein,
the optical element comprises the transmission surface and a reflection surface disposed opposite to the transmission surface, and the optical element is arranged in the first inner cavity such that the optical element is located at an intersection of an emission light path of the first emission beam of the first light emission assembly and an emission light path of the second emission beam of the second light emission assembly, and the transmission surface of the optical element is aligned with the first light emission assembly while the reflection surface of the optical element is aligned with the second light emission assembly; the transmission surface of the optical element is configured to transmit most portion of the first emission beam and reflect a small portion of the first emission beam; and the inclined plane is configured to re-reflect the small portion of the first emitting beam reflected by the transmission surface.

4. The optical module according to claim 3, wherein,
the first inner cavity is provided therein with a support platform, and the support platform is arranged such that a distance between the support platform and the second incident light port gradually increases in an emission direction of the first emission beam, with a first angle formed between the support platform and the emission direction of the first emission beam; and
the optical element is disposed on the support platform, and the support platform is provided with a light hole such that the first emission beam of the first light emission assembly can pass through the light hole and come onto the optical element.

5. The optical module according to claim 4, wherein the inclined plane is arranged below the support platform such that a distance between the inclined plane and the second incident light port gradually decreases in the emission direction of the first emission beam.

6. The optical module according to claim 5, wherein an angle formed between the inclined plane and the emission direction of the first emission beam is a second angle, and the second angle is between 20° to 50°.

7. The optical module according to claim 4, wherein the first angle is 45°.

8. The optical module according to claim 2, wherein an isolator is provided in the second inner cavity of the first tubular shell at a focal point of the first emission beam.

9. The optical module according to claim 1, wherein the support frame of the light splitting assembly comprises a first connecting portion, a support portion and a second connecting portion, and wherein the first connecting portion is connected to the second connecting portion via the support portion, and the support frame is provided therein with a through hole that runs through the first connecting portion, the support portion and the second connecting portion;
the support portion is provided with a first support surface, a first stop surface, a second support surface, a second stop surface and a third support surface, wherein
the first support surface is arranged at a third angle relative to the emission direction of the first emission beam inside the first tubular shell such that a distance between the first support surface and the first connecting portion gradually increases in the emission direction of the first emission beam; the first stop surface is connected between the first support surface and the first connecting portion at a first end of the first support surface; the first optical splitter is attached, at one side thereof, to the first support surface, with one end of the first optical splitter abutting against the first stop surface;
the second support surface is arranged towards the first reception light port at a second end of the first supporting surface opposite to the first end of the first supporting surface, and is arranged at a fourth angle relative to the emission direction of the first emission beam such that a distance between the second support surface and the second connecting portion gradually decreases in the emission direction of the first emission beam; the second stop surface is connected between the second support surface and the second connecting portion; and the third optical splitter is attached, at one side thereof, to the second support surface, with one end of the third optical splitter bearing against the second stop surface and the other end thereof abutting on the first connecting portion, and the third optical splitter is located above the first optical splitter;
the third support surface is arranged on the support portion towards the second reception light port, and at a fifth angle relative to the emission direction of the first emission beam inside the first tubular shell, such that a distance between the third support surface and the second reception light port gradually decreases in the emission direction of the first emission beam; and the second optical splitter is attached, at one side thereof, to the third support surface; and
the light hole runs through the first support surface and second support surface, and the third support surface is provided therein with a through hole communicated with the light hole; the multi-path reception beams transported from the fiber adapter will pass through the light hole and come onto the first optical splitter, and then come onto the second optical splitter after being reflected by the first flitter and passing through the through hole, and the second reception beam re-reflected by the second optical splitter will pass through the through hole and the light hole and then come onto the third optical splitter.

10. The optical module according to claim 9, wherein
a reflection surface is provided on one side of the first optical splitter facing the fiber adapter, such that the first reception beam and the second reception beam from the fiber adapter can be reflected at the reflection surface;
a transmission surface is provided on an upper surface of the second optical splitter exposed through the through hole, and a transmission-reflection surface is provided on a lower surface of the second optical splitter facing the second reception light port, the transmission-reflection surface being configured to re-reflect the first reception beam reflected by the first optical splitter and transmit the second reception beam reflected by the first optical splitter; and
a transmission surface is provided on a lower surface of the third optical splitter facing the first optical splitter, and the first reception beam re-reflected by the second optical splitter transmits through the third optical splitter through the transmission surface of the third optical splitter.

11. The optical module according to claim 9, wherein the third angle is 40° to 50°, the fourth angle is 6° to 20°, and the fifth angle is 10° to 22°.

12. The optical module according to claim 11, wherein the third angle is 45°, the fourth angle is 8°, and the fifth angle is 16°.

13. The optical module according to claim 9, wherein an angle formed between the mounting surface of the bracket and the beam emission direction is the same as the fifth angle.

14. The optical module according to claim 13, wherein the bracket is provided with a light hole that runs through the mounting surface and the insertion surface, and the light hole of the bracket is aligned with the first reception light port.

15. The optical module according to claim 9, wherein
the first light emission assembly is provided with a coupling lens at an light exiting end of the first light emission assembly, which is configured to convert the first emission beam emitted by the first light emission assembly into a converged beam;
a collimating lens is disposed in a section of the light hole that is located in the first connecting portion, and the collimating lens is configured to convert the first emission beam transmitted through the optical element and the second emission beam reflected by the optical element into collimated beams, respectively; and
a converging lens is disposed in an end of the fiber adapter inserted into the integrated emission and reception light port, and the converging lens is further inserted into the second connecting portion, and is configured to convert the collimated beam coming into the converging lens after passing through the first optical splitter disposed on the first support surface into a converged beam.

16. The optical module according to claim 1, wherein
the first tubular shell comprises a first lateral side and a second lateral side that are opposite to each other, as well as a top side and a bottom side that are connected between the first and second lateral sides, and the top side is opposite to the bottom side; and
the first incident light port is located on the first lateral side, the second incident light port and the first reception light port are arranged side by side on the top side, the second reception light port is located on the bottom side, and the integrated emission and reception light port is located on the second lateral side.
